(19) United States
(12) Patent Application Publication
(10) Pub. No.: US 2023/0090078 A1
(43) Pub. Date: Mar. 23, 2023

(54) SYSTEMS, APPARATUS, AND METHODS FOR HUMAN-TO-MACHINE NEGOTIATION

(71) Applicant: Mark Wang, San Diego, CA (US)

(72) Inventor: Mark Wang, San Diego, CA (US)

(21) Appl. No.: 17/934,571

(22) Filed: Sep. 22, 2022

Related U.S. Application Data
(60) Provisional application No. 63/246,794, filed on Sep. 22, 2021.

(51) Int. Cl. G08G 1/0967

(52) U.S. Cl. CPC G08G 1/096791; G08G 1/096733

(57) ABSTRACT

Systems, apparatus, and methods for human-to-machine negotiation. Self-driving vehicles are expected to greatly improve the quality and efficiency of human life. Unfortunately, self-driving vehicles have struggled to effectively communicate with other human drivers. Various aspects of the present disclosure are directed to fleets that can bargain as a collective group. While the present disclosure describes a fleet of self-driving vehicles, the concepts are broadly applicable to any fleet of participants (machine, human, and/or hybrids). A transaction ledger in combination with a fleet of informed observers allows for systemic efficiencies that would not otherwise be possible, even among human drivers. Specifically, once enough informed observers are present (e.g., a fleet) cooperative bargaining becomes much more desirable than adverse bargaining.

### PRIORITY

This application claims the benefit of priority to U.S. Provisional Patent Application Ser. No. 63/246,794 filed Sep. 22, 2021 and entitled “SYSTEMS, APPARATUS, AND METHODS FOR HUMAN TO MACHINE NEGOTIATION”, the foregoing incorporated by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of user and machine interactions. More particularly, the present disclosure relates to systems, computer programs, devices, and methods for enabling a machine to negotiate with humans.

### DESCRIPTION OF RELATED TECHNOLOGY

Humans have developed a variety of ways to communicate driver intent. There are explicit rules and implicit behaviors that affect human driving. “Explicit rules” are typically codified and/or enforced for traffic safety; for example, a human driver merging into (or out of) traffic may conform to posted speed limits and use their blinker to signal intent. “Implicit behaviors” are less well-defined because they often vary between individuals. An aggressive driver may “force” a merge by dangerously edging their vehicle into a lane; inattentive drivers may fail to signal before turning or fail to turn off their blinkers afterwards (incorrect signaling). Over years of practice, human drivers acquire an immense amount of practical driving experience.

Self-driving vehicles are expected to greatly improve the quality and efficiency of human life. Machines do not require rest and do not have attention spans, thus certain applications (long-haul trucking) could be handled more safely and efficiently by self-driving vehicles. Self-driving vehicles may also allow humans to focus their time and energy on other tasks (e.g., reading the news or catching up on email during long commutes). Traffic congestion may also be rooted in inefficient human navigation and/or habits; self-driving vehicles may reduce congestion by distributing traffic across less-well-traveled routes.

Unfortunately, self-driving vehicles have struggled to effectively communicate with other human drivers. The problem is two-fold, not only must machines learn how to communicate with human drivers, but humans must also learn how to communicate with machines. More directly, driving algorithms cannot possibly enumerate the myriad of implicit behaviors that would be necessary for fully autonomous driving. Similarly, humans must learn how to understand the intention of a self-driving vehicle when there is no human driver to make eye contact and/or exchange hand signals.

### BRIEF DESCRIPTION OF THE DRAWINGS

FIGS. 1A and 1B are graphical representations of a first merging scenario, useful to illustrate various aspects of the present disclosure.

FIGS. 2A and 2B are graphical representations of a first exemplary merging scenario, in accordance with various aspects of the present disclosure.

FIGS. 3A and 3B are graphical representations of a second exemplary merging scenario, in accordance with various aspects of the present disclosure.

FIG. 4 is a logical block diagram of a fleet device providing a transaction record to a fleet, in accordance with various aspects of the present disclosure.

FIGS. 5A and 5B are graphical representations of a third exemplary merging scenario, in accordance with various aspects of the present disclosure.

FIG. 6 is a logical block diagram of one exemplary system, in accordance with various aspects of the present disclosure.

FIG. 7 is a logical block diagram of one exemplary fleet device, in accordance with various aspects of the present disclosure.

FIG. 8 is a logical block diagram of a basic processor architecture useful to illustrate various aspects of processor design.

FIG. 9 is a logical block diagram of a basic neural network processor useful to illustrate various aspects of neural network operation.

FIGS. 10A and 10B are a logical block diagram of a “last mile” portion of a communication network, in accordance with various aspects of the present disclosure.

FIG. 11 is a logical block diagram of a backhaul portion of a communication network, in accordance with various aspects of the present disclosure.

FIG. 12 is a logical block diagram of one exemplary user device, in accordance with various aspects of the present disclosure.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### Context: Human-to-Machine Interactions

As a brief aside, letting a vehicle merge-in allows the merging driver to “cut-ahead” of the driver letting them in. Under most conditions, this is a mild inconvenience—but most humans will let another driver in out of a feeling of kindness, karma, or both; usually, the “let-in” driver may acknowledge this charity with a friendly wave. Unfortunately, in high traffic scenarios, humans are often frustrated. Even the most karmically-minded person is less inclined to let another driver in. In many cases, the merging driver may attempt to dangerously “edge” their vehicle into the lane; oftentimes this becomes an implicit showdown between the merging driver's aggression and the in-lane driver's resolve.

Machines cannot offer a friendly wave of acknowledgement or karmic return, thus humans have very little incentive to let-in a self-driving vehicle. Additionally, self-driving vehicles are programmed to drive in a very cautious manner. Self-driving vehicles also operate in a legal gray area (circa 2022). It is not clear who is at fault if the self-driving vehicle causes an accident—i.e., is the driving algorithm incorrectly programmed (the vehicle manufacturer's fault), should the owner of the vehicle be liable, should the other driver be liable? As a result, self-driving vehicles often cannot interact in the same way that other humans do.

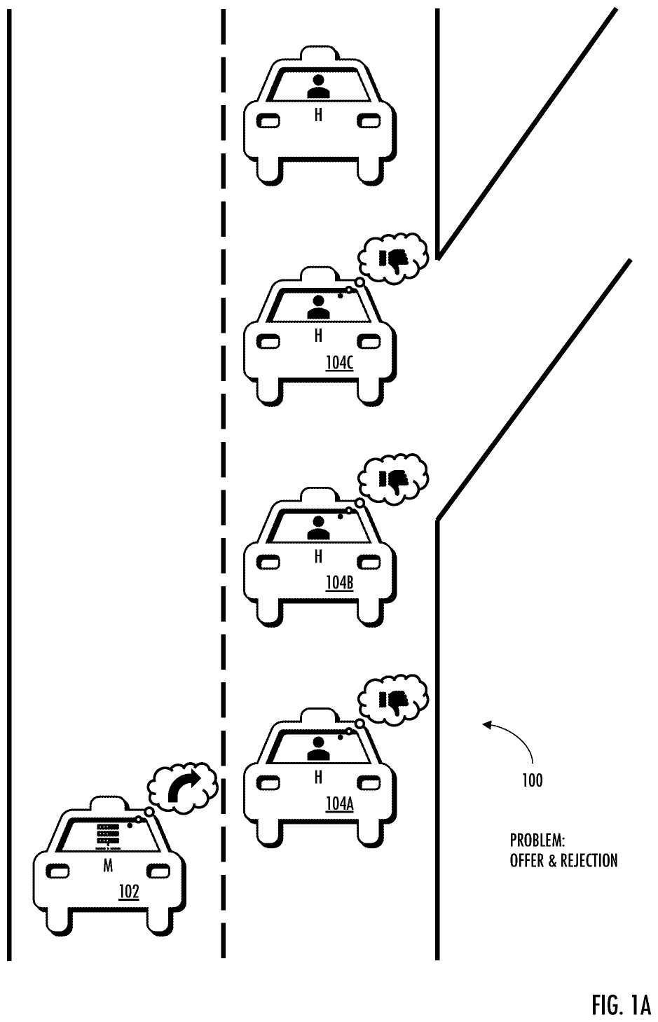

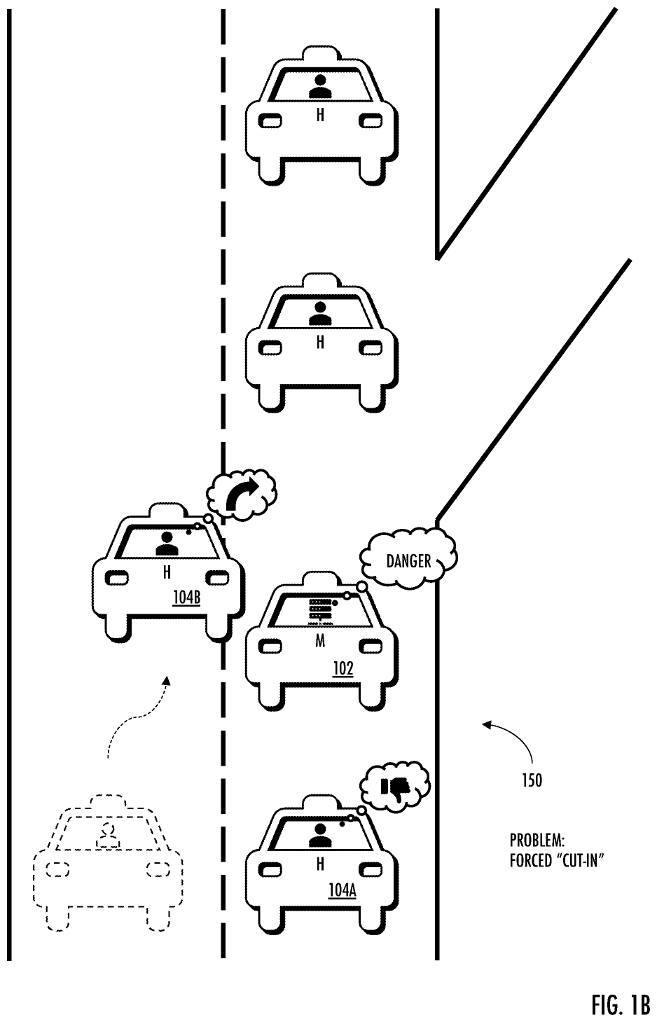

Consider the first scenario 100 shown in FIG. 1A where a self-driving vehicle 102 is attempting to merge into the rightmost lane to exit. The rightmost lane has four human-driven vehicles (104A, 104B, 104C) locked in traffic. In this example, the human driver of human-driven vehicle 104A is frustrated and does not let-in the self-driving vehicle 102. As the self-driving vehicle 102 moves slowly up the leftmost lane, their odds for getting let-in get progressively worse. Human-driven vehicles (104B, 104C) have been waiting as long as human-driven vehicle 104A, and similarly decline. In this case, the self-driving vehicle 102 misses the exit and must try again at the next exit opportunity. Worse still, the self-driving vehicle slowed down to attempt to merge into the rightmost lane; this wasted braking and acceleration may also contribute to overall traffic burden.

Additionally, consider a second scenario 150 shown in FIG. 1B, where the self-driving vehicle 102 is in the rightmost lane. In this case, a human driver in human-driven vehicle 104B is trying to exit and tries to signal human-driven vehicle 104A. Unfortunately, human-driven vehicle 104A does not let-in human-driven vehicle 104B; however, the human driver in human-driven vehicle 104B realizes that the self-driving vehicle 102 is a self-driving vehicle because there is no one in the driver seat. In a rush, human-driven vehicle 104B quickly accelerates and performs a dangerous cut-in. The self-driving vehicle 102 performs an emergency maneuver to avoid a collision and lets-in human-driven vehicle 104B. As a practical matter, even if the self-driving vehicle 102 avoids a collision with human-driven vehicle 104B, the sudden erratic response may catch the human-driven vehicle 104A off-guard; in some cases, the self-driving vehicle 102 may be rear-ended by the human-driven vehicle 104B.

As shown in both the first scenario 100 and the second scenario 150, other human drivers can take advantage of a self-driving vehicle's conservative behavior. In some cases, this may introduce a perverse moral hazard for humans to drive dangerously. As a result, erratic acceleration/braking may propagate through the entire traffic pattern worsening traffic.

### Example Operation: Negotiating as a Fleet Of Machines

As a brief aside, “game theory” refers to the study of strategic interactions among rational agents. The “Pirate Game” is one famous thought experiment, see Table 1 below:

TABLE 1
The Pirate Game

Problem:
Five rational pirates find 100 gold coins. They must decide how to
distribute them. The five rational pirates have a strict order of seniority:
1st Anne Bonny (A), 2nd Blackbeard (B), 3rd Calico Jack (C), 4th Sir
Francis Drake (D), and 5th Edward Low (E).
Under the pirate rules of distribution, the most senior pirate first
proposes a plan of distribution. All pirates, including the proposer, then
vote on whether to accept this distribution. If the majority accepts the
plan, the coins are dispersed and the game ends. If the majority rejects
the plan, the proposer is thrown overboard from the pirate ship and dies,
and the next most senior pirate makes a new proposal to begin the system
again. In case of a tie vote, the proposer has the casting vote. The process
repeats until a plan is accepted or if there is one pirate left.
The pirates base their decisions on four factors. First, each pirate wants
to survive. Second, each pirate wants to maximize the number of gold
coins they receive. Third, each pirate would prefer to throw another
overboard if all other results would otherwise be equal. And finally, the
pirates do not trust each other, and will neither make nor honor any
promises between pirates apart from a proposed distribution plan that
gives a whole number of gold coins to each pirate.
Solution:
A quick mental experiment quickly demonstrates the complexity of the
problem. When the pirates vote, they will not just be thinking about the
current proposal, but also other outcomes down the line. In addition, the
order of seniority is known in advance so each of them can accurately
predict how the other pirates might vote in any scenario.
If Pirate A suggests an equitable distribution e.g., A: 20, B: 20, C: 20,
D: 20, E: 20, then B will realize that they can offer a better distribution
without Pirate A and vote for Pirate A to be thrown overboard. In other
words, B will not vote for A’s proposal since B can offer B: 25, C: 25,
D: 25, E: 25. C will not vote for A’s proposal (or B’s proposal) since
C can wait for C:34, D: 33, E: 33, etc.
Working backwards, Pirate A realizes that the final possible scenario
would have all the pirates except D and E thrown overboard. Since D is
senior to E, D has the casting vote. D would propose to keep 100 for
themself and 0 for E. Pirate A realizes that Pirate E does not want this
scenario to occur.
If there are three pirates left (C, D and E), C knows that D will offer E 0
in the next round; therefore, C has to offer E one coin in this round to
win E's vote. Pirate A reasons that when only three pirates are left,
Pirate C would offer C: 99, D: 0, E: 1.
If B, C, D and E remain, B can offer 1 to D; because B has the casting
vote and only D's vote is required. Thus, B would propose B: 99, C: 0,
D: 1, E: 0. Notably, B might consider proposing B: 99, C: 0, D: 0, E: 1,
as E knows it won't be possible to get more coins if E throws B over-
board. However, as each pirate is eager to throw the others overboard,
E would prefer to kill B, to get the same amount of gold from C.
With this knowledge, A can count on C and E's support for the following
allocation. A: 98, B: 0, C: 1, D: 0, E: 1.

The Pirate Game illustrates so-called “ultimatum” bargaining with an ordered queue of participants. While the Pirate Game optimizes for a participant's own behavior, there is very little discussion in game theory and/or related literature regarding the system-wide benefits of “line jumping” in unmanaged queues. As noted in, for example, Cutting in Line: Social Norms in Queues to Allon et al., first published in Management Science, Vol. 58, No. 3, March 2012, incorporated by reference in its entirety, unmanaged queues present unique barriers to efficient bargaining. Firstly, unmanaged queues do not have an authority entity, thus there is no coordinated assignment of priority to the participants nor any enforcement/adjudication mechanism. Additionally, each participants' relative importance/urgency is unknown to the other participants. While selective line jumping may improve system-wide efficiency, any participant could convey information (or misinformation) to other participants without consequence. Allon finds that “[w]hen customers play the game only once, we show that the only possible priority rule that can emerge in equilibrium is FIFO.” Conceptually, these findings may be broadly extended to traffic queues; in other words, human drivers have established a social norm of FIFO priority for traffic patterns because of imperfect bargaining. Under current systems, letting-in another driver is an irrational behavior, even though a system-wide analysis would predict that some line jumping is desirable and should be encouraged.

Recently, it has been proposed that a fleet of self-driving vehicles could be used for repetitive tasks (logistics, shipping, etc.) Unlike a human driver that must interact with an anonymous population of other drivers, a fleet of machines can leverage bargaining and information advantages based on its size. In other words, a fleet has advantages that were not previously available to single humans. Various aspects of the present disclosure are directed to fleets that can bargain as a collective group. While the present disclosure describes a fleet of self-driving vehicles, the concepts are broadly applicable to any fleet of participants (machine, human, and/or hybrids).

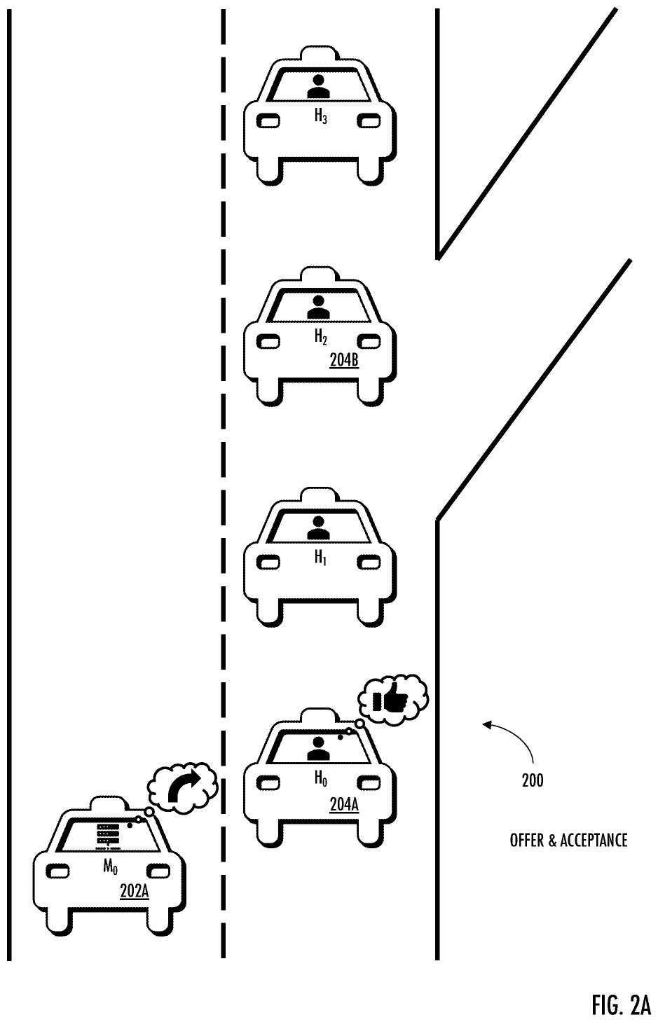

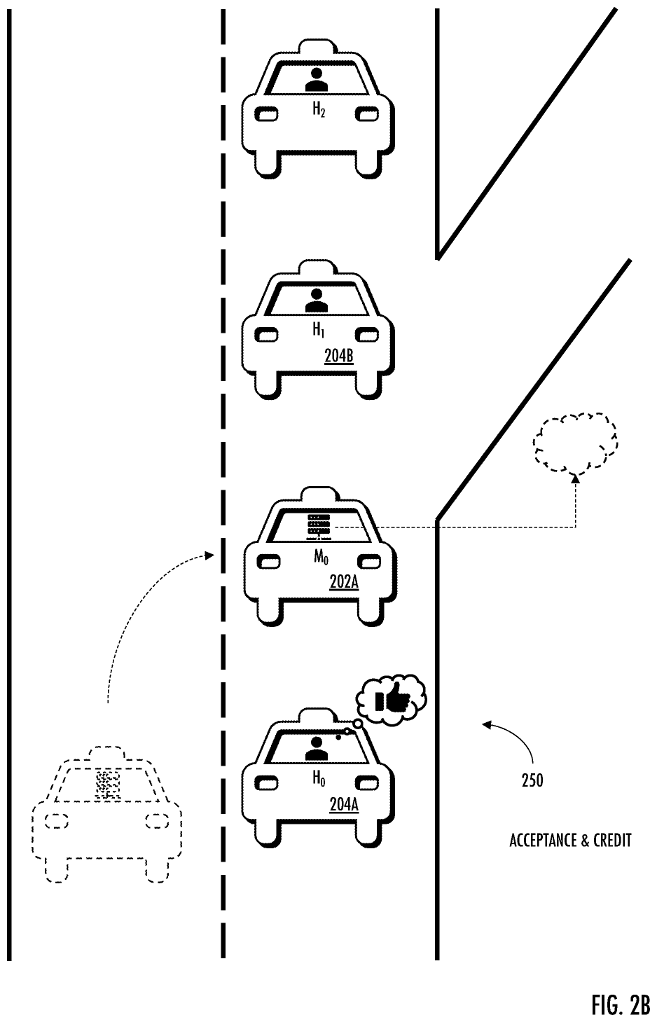

Turning now to FIG. 2A, a self-driving vehicle (M₀ 202A) requests to merge (scenario 200). As part of the request, the self-driving vehicle (M₀ 202A) offers subsequent merges for any of its fleet cohort. The human driver (H₀ 204A) accepts the offer and lets-in the self-driving vehicle (M₀ 202A). As shown in FIG. 2B, once the offer has been accepted and the performed, the self-driving vehicle (M₀ 202A) transmits a credit to a ledger of credits and debits for its fleet cohort (scenario 250). In one specific variant, the transmission may use wireless networking (e.g., 5G/6G cellular network access).

Notably, unlike adversarial “let-in” negotiations, the self-driving vehicle (M₀ 202A) has offered something of value to the human driver (H₀ 204A). In other words, both parties are incentivized to achieve a desired outcome. For example, self-driving vehicle (M₀ 202A) may explicitly signal its intent to merge, and the human driver (H₀ 204A) may explicitly signal its intent to allow the merge. If the self-driving vehicle (M₀ 202A) needs space to merge, then the onus may be on the human driver (H₀ 204A) to create space (by slowing down, by following vehicle 204B at a larger distance, etc.)

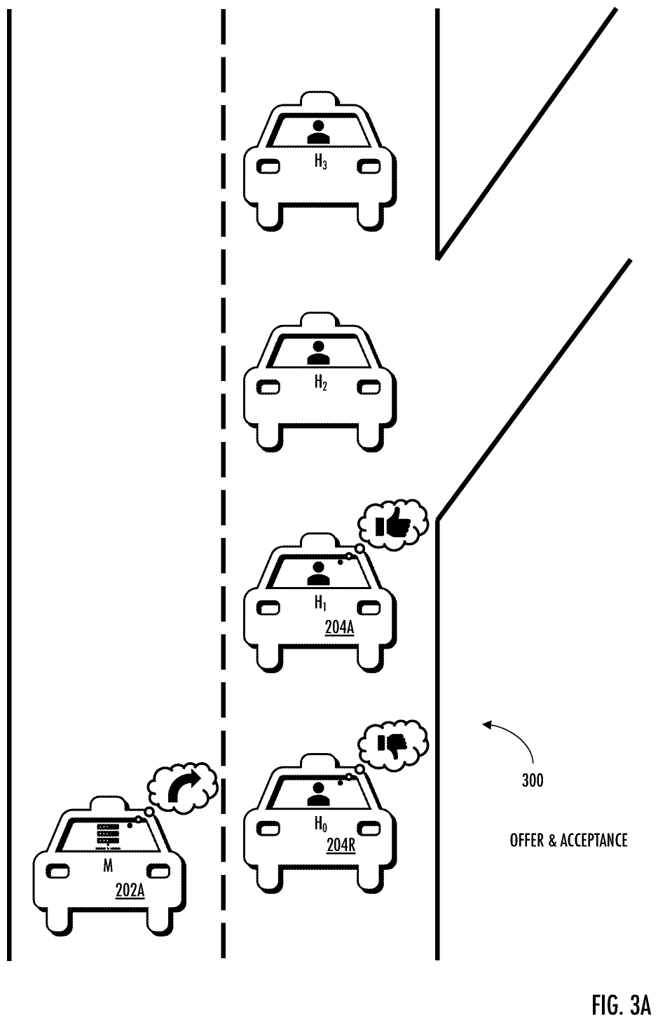

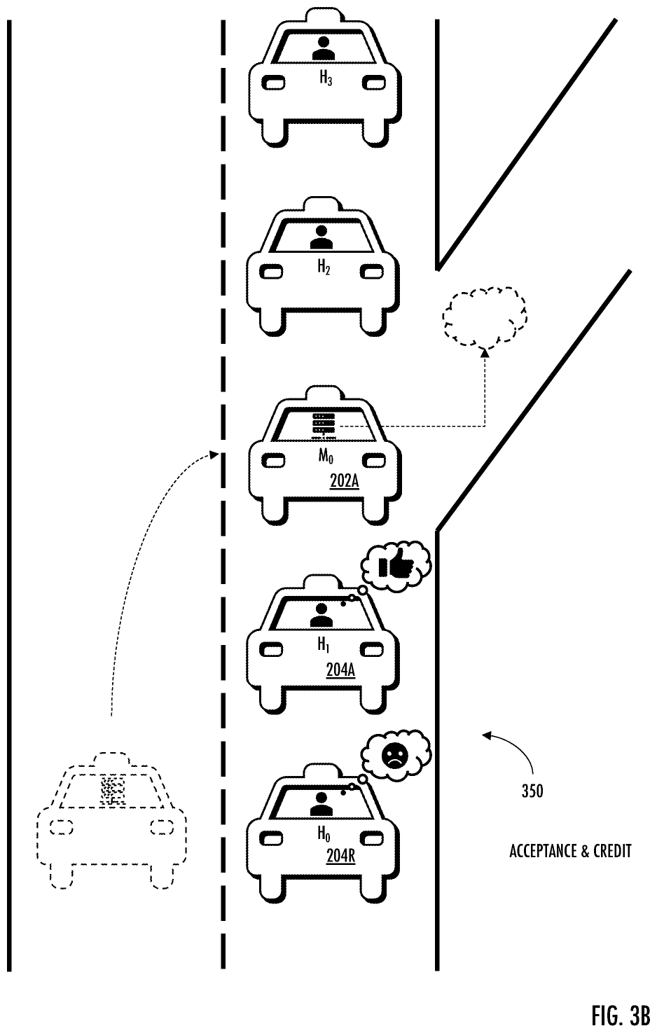

As a practical matter, some human drivers may not want to cooperate. Referring now to FIG. 3A, a first driver (H₀ 204R) rejects the self-driving vehicle's offer, however the second driver (H₀ 204A) accepts (scenario 300). In this case, referring now to FIG. 3B, however, only the second driver (H₀ 204A) benefits from the offer; the first driver (H₀ 204R) receives nothing (scenario 350). In other words, the self-driving vehicle (M₀ 202A) uses a form of ultimatum bargaining, much like the Pirate Game (described above). A human driver will quickly learn to consider both the current proposal, as well as the likely outcomes down the line. In this example, purely adversarial behavior is counterproductive.

Changing the negotiation from adversarial to cooperative creates multiple messaging efficiencies. Adversarial bargaining incentivizes misinformation (lying), bluffing, and/or other perverse behaviors. For instance, the aforementioned showdown between a merging driver's aggression and an in-lane driver's resolve is a bluffing game (even though neither driver wants to get into a car accident). Similarly, drivers that plead to be let-in (e.g., “Just this once, I'm in a hurry!”) could be lying. In contrast, cooperative bargaining can be implemented even with very simple binary signaling (“accept”, “reject”) because misinformation is penalized—this results in a much simpler communication, and greatly reduces the processing complexity. More directly, a self-driving vehicle does not need to infer driver intent from the driver's actions, instead the self-driving vehicle is explicitly told what the driver intends to do (or not do). The self-driving vehicle must still implement precautions, however, expressly communicated driver intent removes messaging ambiguity.

In simple embodiments, the self-driving vehicle and human could communicate with existing signaling mechanisms. For example, the self-driving vehicle could use its left blinker to signal its intent, the driver could quickly pump their brake lights to signal acceptance. Once the driver slows down to create space for the self-driving vehicle, the self-driving vehicle enters the lane in the newly created space. The self-driving vehicle turns off the blinker to indicate successful performance.

In more complex embodiments, the self-driving vehicle and human driver may communicate using specialized signaling and/or apparatuses. This may include visual signals (lights), audible signals (horns), haptic symbols (rumble boxes), and/or other commonly available user interfaces (e.g., smart phones, and/or vehicle-mounted touchscreen interfaces). For example, a self-driving vehicle may use wireless communication to identify other wirelessly connected drivers along its path. A text message or other in-application notification could be used to notify drivers of an offer. A driver that accepts the message will be notified of the self-driving vehicle's identifying marks (e.g., a license plate, make, model, external lighting, and/or other unique indicia, etc.) Unique indicia ensures that both the human driver and the self-driving vehicle can correctly identify one another and perform the merge when necessary.

Various aspects of the offer may be negotiated prior-to, or concurrent-with, the offer/acceptance. In simple embodiments, the credit may be a known value (e.g., a one-for-one exchange); in other embodiments, the credit may have a variable value (e.g., one-for-two, one-for-four, etc.) Variable value credits may allow the participants to efficiently negotiate priority; for example, as a self-driving vehicle gets closer to the turn-off, they may increase their offer to increase their acceptance rate. In some cases, variable valued credits may also allow some fleets to compensate with more bargaining power than other fleets. For example, a very large fleet may offer one-to-one exchange; a smaller fleet may have to increase their exchange to get takers. While the illustrated example is described in terms of an in-kind transfer (let-in-now, be-let-in-later), other types of credit may be substituted with equal success. For example, a shipping fleet may offer preferential shipping and/or discounts for human drivers that cooperate with them.

There may be situations where a driver attempts to perform (e.g., let-in the self-driving vehicle), but is unable to complete performance (“substantial performance”). As but one such example, a driver in moving traffic may slow down in good faith to create space, but the self-driving vehicle may not be able to move into the space based on its own lane conditions (e.g., a motorcycle lane splitting, etc.) In other examples, the driver may take an offer but actively “breach” the terms of the offer. In such instances, the self-driving vehicle may capture footage of the event for subsequent adjudication (substantial performance, breach, etc.) and determination of remedy. In other words, failure to perform is not a time-sensitive decision; the self-driving vehicle can continue to drive conservatively (rather than attempt a forced cut-in).

As a brief aside, while U.S. jurisprudence generally forbids blanket surveillance, many (if not all) states have “probable cause” exceptions for traffic surveillance based on neutral criteria (e.g., DUI checkpoints, etc.) Empirical and anecdotal evidence also strongly suggests that many opportunistic traffic violations occur while merging into/out-of lanes. Thus, adjudication footage captured by the fleet may be provided to law enforcement to penalize particularly perverse and/or dangerous behavior (such as cutting across multiple lanes of traffic to cut into an open spot, etc.) This may be particularly important to ensure communal safety and/or valuable as a source of accident/insurance assessment. In other words, a fleet of observers can also provide law enforcement and civil parties a visual record about driver behavior both up-to and immediately after a triggering incident.

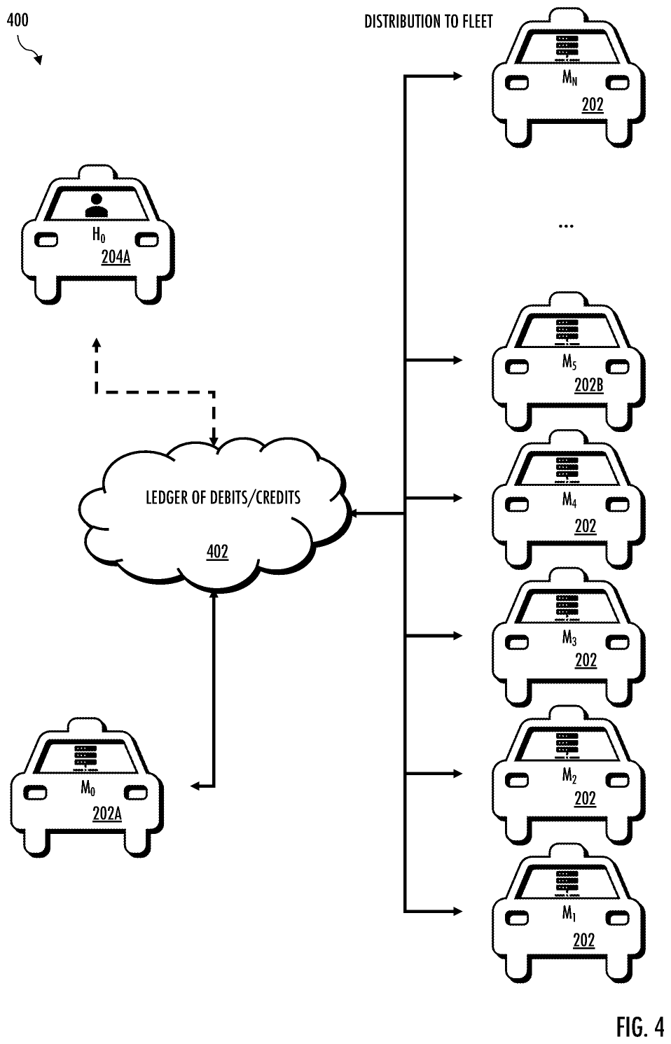

Referring now to FIG. 4, a ledger 402 of credits and debits is kept for both participants and passive participants in scenario 400. Active participants update the ledger with transactions. Passive participants do not actively interact with the ledger 402, however their information is useful and is also recorded in the ledger. More directly, even if the ledger has only one active participant, the credits and debits have exchange utility to passive participants (e.g., the fleet will reimburse cooperation according to the ledger records).

Conceptually, the ledger 402 in combination with a fleet of informed observers allows for systemic efficiencies that would not otherwise be possible. As postulated in Cutting in Line: Social Norms in Queues to Allon et al.: “[w]hen players engage in a repeated game, and there is perfect monitoring of past actions . . . legitimate intrusions may be used to improve the system performance by reducing the expected waiting cost . . . This behavior is supported by a threat to move to a socially inferior FIFO priority, which is also inferior on an individual basis under the conditions we characterize.” In other words, not only does the fleet benefit, but (perhaps more surprisingly) the human drivers are also significantly helped as well. Once enough informed observers are present (e.g., a fleet), cooperative bargaining becomes much more desirable—adverse bargaining techniques will quickly diminish.

In one embodiment, the ledger is a collection of accounts against which active participants can add (credit) or subtract (debit). The credit/debits may be made in whole units and/or fractions. Every debit in the ledger has a corresponding credit (e.g., the transactions balance). In some implementations, the active participants may be allowed a certain amount of negative balance without penalty; in other implementations, the active participants may be provided a starting balance, but negative balances may be penalized. The ledger administration may charge fees based on excessive transactions and/or levy penalties against large balances.

In one embodiment, a fleet is a single active participant. Individual human drivers associated with one or more license plates are other participants. In some cases, the ledger may be managed by a fleet for its individual transactions. In other cases, the ledger may be managed by a 3^{rd} party (e.g., a management consortium) to track multiple participants. While the techniques may have been discussed in the context of human-to-machine negotiations, artisans of ordinary skill in the related arts will readily appreciate that human drivers (and human fleets) could also benefit from these technologies. For example, a human-driven fleet (e.g., ride-share) may be treated as a fleet participant.

Each ledger transaction may identify the transacting parties (e.g., fleet-to-person, fleet-to-fleet, person-to-person, etc.), and the exchanged credit/debit. In some cases, the exchange may be variable depending on urgency (e.g., surge pricing) and/or bargaining power (e.g., fleet size). More generally, however, the credit/debit transactions identify the terms of the offer (the value being exchanged and/or any contingencies), the accepting party/performant party, and the final disposition (successful performance, partial performance or substantial performance, non-performance or breach). In some cases, additional information may be recorded with each transaction for verification and/or validation purposes. Such metadata may include, e.g., time and/or date stamps, location stamps, snapshot images/footage, certainty of identification, cryptographic hashes, unique one-time handshakes, and/or other transaction metadata for improving accuracy and/or reliability of the ledger.

While the illustrated example is explained in the context of self-driving vehicles 202 updating the ledger 402, it is readily appreciated that any active participant (with appropriate verification) could update and/or inspect the ledger 402. For example, a human driver (H₀ 204A) with a secure smart vehicle application could also provide a debit transaction that corroborates the self-driving vehicle's credit transaction (M₀ 202A). To deter fraudulent transactions, the ledger 402 may employ a variety of different techniques to determine authenticity. For example, the ledger may check not only the time, date, and location of a proposed ledger transaction, but also previous ledger transactions, participant activity, and/or participant metadata (e.g., user/vehicle pairing, software versioning, access restrictions, etc.). Fraudulent behavior may be punished with fees, account suspension, and/or reported to law enforcement. In one specific variant, ledger account access may employ so-called “zero-trust” networking principles.

Even though active participants could update the ledger 402 as each transaction occurs, it may be more efficient to transfer credits/debit transactions in bulk. For example, the active participants may each locally cache a number of credits and debits which are updated periodically, as-needed, as-requested by an active participant, or whenever otherwise convenient (e.g., during periods of inactivity). In some embodiments, active participants may only locally cache a subset of transactions that it is likely to encounter. For example, an in-city self-driving vehicle in the county of San Diego may only update its local cache with information for San Diego and its surrounding counties over the past few days. In contrast, a long-haul trucker that will pass through California, Oregon, and Washington, may update its local cache with information for major stops along the interstate highways. In some implementations, it may be useful to split updates into multiple phases. For example, balance updates may be split into a first phase of credits/debits to existing locally cached accounts, and a second phase of importing new accounts/purging stale accounts.

In this example, the self-driving vehicle (M₀ 202A) adds a credit to the human driver's account (H₀ 204A) and debits the fleet's account. If the human driver is an active participant, the transaction may be checked for corroboration (e.g., the human driver's account (H₀ 204A) would claim a debit from the fleet's account for the same time, date, location, etc.) The fleet's record of accounts is distributed to its fleet of self-driving vehicles, which includes self-driving vehicle (M₅ 202B).

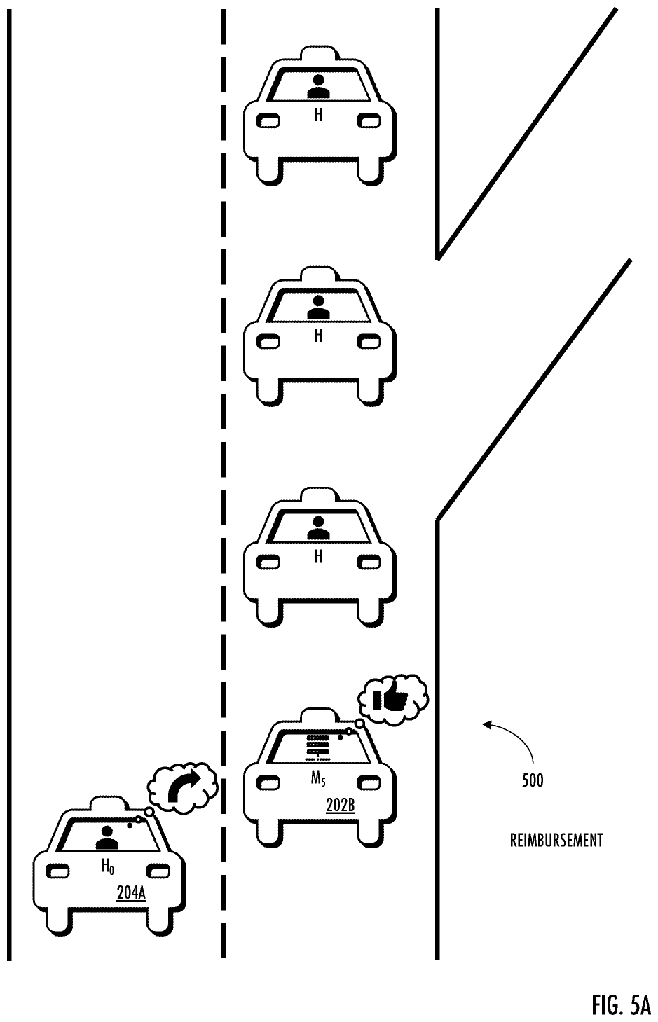

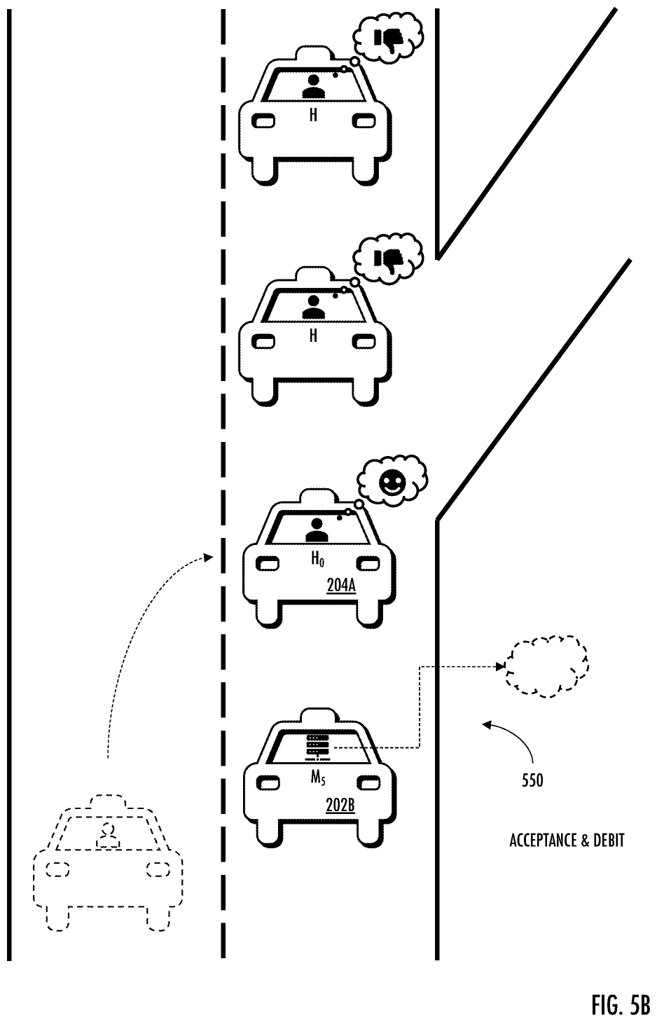

A few days later, the human driver (H₀ 204A) is looking to merge (the scenario 500 depicted in FIG. 5A). The human driver (H₀ 204A) turns on their left blinker to signal their intent. A nearby member of the fleet cohort (self-driving vehicle (M₅ 202B)) checks its local ledger, recognizes that the human driver (H₀ 204A) has a credit, and offers to reimburse. In simple embodiments, the self-driving vehicle (M₅ 202B) could quickly flash its brake lights to signal acceptance; in more complex embodiments, the self-driving vehicle (M₅ 202B) could send a text message or other in-application notification to notify the human driver (H₀ 204A). The human driver (H₀ 204A) sidles up next to the self-driving vehicle (M₅ 202B); responsively, the self-driving vehicle (M₅ 202B) creates space for the human driver (H₀ 204A) in the rightmost lane. Once the human driver (H₀ 204A) has been successfully reimbursed, the self-driving vehicle (M₅ 202B) transmits a debit transaction to the ledger (depicted in scenario 550 of FIG. 5B). If the human driver (H₀ 204A) is an active participant, their credit transaction may also be sent to the ledger to corroborate.

### System Architecture

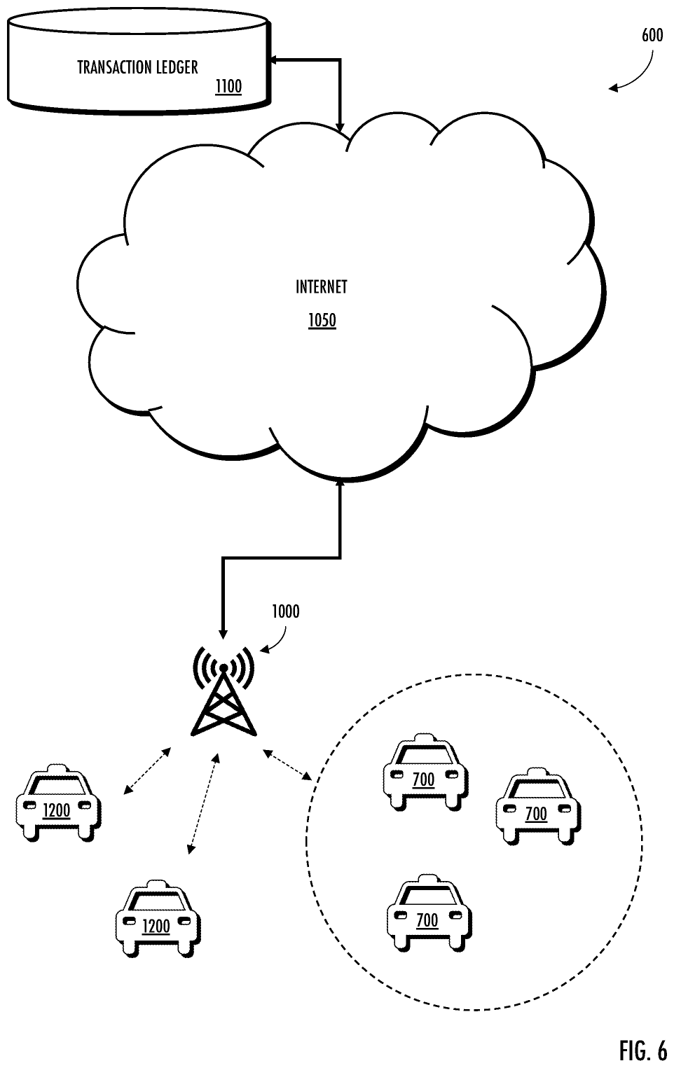

FIG. 6 is a logical block diagram of the exemplary system 600. The system 600 includes: a plurality of fleet devices 700, one or more user devices 1200, communication networks 1000 and 1050, and transaction ledgers 1100. During system operation, the fleet devices 700 and user devices 1200 negotiate actions based on locally cached records of credits and debits. The communication networks 1000 and 1050 allow active participants to communicate records back to the transaction ledger 1100 for reconciliation and long-term archival. In some cases, the communication networks 1000 and 1050 may also facilitate discovery and communication between fleet devices 700 and user devices 1200, if necessary.

While the present discussion describes fleets of self-driving vehicles, the system may have broad applicability to any unmanaged system that would benefit from informed participation between human and machine entities. Such applications may include industrial, financial, medical, and/or scientific resource management including e.g., network connectivity, energy usage, and/or water distribution. Some such systems have previously attempted to use currency or other forms of monetary exchange as a signaling scheme (e.g., payment for prioritized broadband access, payment for water rights, etc.). Unfortunately, however, the universal utility of money often incentivizes perverse and/or undesirable arbitrage, especially in systems where an artificial contest (e.g., first-in-time) pits computerized agents against human agents for priority (e.g., first-in-line). The cooperative bargaining techniques described throughout may be used to reduce transaction friction more efficiently, equitably, and cost effectively than many monetary signaling techniques.

The following discussion provides functional descriptions for each of the logical entities of the exemplary system 600. Artisans of ordinary skill in the related arts will readily appreciate that other logical entities that do the same work in substantially the same way to accomplish the same result are equivalent and may be freely interchanged. A specific discussion of the structural implementations, internal operations, design considerations, and/or alternatives, for each of the logical entities of the exemplary system 600 is separately provided below.

### Functional Description of Fleet and Fleet Devices

As used herein, a “fleet” refers to a plurality of “fleet devices” (e.g., fleet devices 700 of FIG. 6) that are associated with a fleet account of a transaction ledger (e.g., transaction ledger 1100 of FIG. 6). Typically, a fleet may be directed and/or controlled by a “control entity”. Functionally, the control entity may aggregate the bargaining state (credits/debits) of multiple fleet devices within a one or more fleet accounts.

Within this context, “control” and its linguistic derivatives refers to logical and/or physical control over the way an action or task is performed; “direct” and its linguistic derivatives refer to logical and/or physical control over the result of the action or task. Factors that are typically used to control or direct an entity's action or task performance include e.g., goal setting, time constraints, duration constraints, constraints on a manner of performance, authority over the task, responsibility for the task performance, incentives and/or disincentives for task performance, and/or any other metric of activity/task performance.

As a brief aside, the Society of Automotive Engineers (SAE) has published a classification of autonomy which includes: No Automation (Level 0), Driver Assistance (Level 1), Partial Automation (Level 2), Conditional Automation (Level 3), High Automation (Level 4), Full Automation (Level 5) (see e.g., Taxonomy and Definition for Terms Related to Driving Automation Systems for On-Road Motor Vehicles, published Dec. 20, 2021, incorporated by reference in its entirety.) Artisans of ordinary skill in the related arts, given the contents of the present disclosure, will readily appreciate that the techniques described herein may benefit fleets of vehicles operating under any degree of autonomy (including Level 0). For reference, a synopsis of the SAE Definitions of Automated Driving are provided in Table 2, below.

TABLE 2
Gradation of Automated Driving

| | | | | Environ- | |
|---|---|---|---|---|---|
| | | | Steering, | ment | Emer- |
| | | Narrative | Accel./ | Monitor- | gency |
| Level | Name | Definition | Decel. | ing | Fallback |
| 0 | No | Human handles | Human | Human | Human |
| | Automation | all aspects of | | | |
| | | driving. | | | |
| 1 | Driver | System handles | Hybrid | Human | Human |
| | Assistance | either steering or | | | |
| | | accel./decel. | | | |
| 2 | Partial | System handles | System | Human | Human |
| | Automation | both steering and | | | |
| | | accel./decel. | | | |
| 3 | Conditional | System may | System | System | Human |
| | Automation | request human to | | | |
| | | intervene. Human | | | |
| | | must respond. | | | |
| 4 | High | System handles | System | System | System |
| | Automation | all aspects of | | | |
| | | driving with | | | |
| | | limitations e.g. . | | | |
| | | terrain, mode, etc | | | |
| 5 | Full | System handles all | System | System | System |
| | Automation | aspects of driving. | | | |
| | | No limitations. | | | |

In one specific example, a fleet of self-driving vehicles may be directed and/or controlled by a corporate entity to deliver goods. While each self-driving vehicle makes real-time decisions regarding road conditions, the corporate entity may specify endpoints for pick-up/delivery within its geographic territories, as well as route traveled, time in transit, etc. As another illustrative example, a ride-share corporation may operate a fleet of human-driven vehicles to provide ride-share services for human passengers. While each human driver makes real-time decisions regarding road conditions, the corporate entity may specify the passenger(s) to be picked up, the time/route to use, and/or compensation for successful execution. In some cases, a corporate entity may break its fleet into smaller manageable sub-fleets. For example, a shipping entity may have sub-fleets for geographic regions (e.g., a northwest fleet, a southwest fleet, northeast fleet, southeast fleet, etc.) The ride-share corporation may split its fleet into full-time drivers and part-time drivers; these sub-fleets may be used to adjust credit exchange rates, etc.

### Functional Description of User Device

Functionally, a “user device” (e.g., user devices 1200 of FIG. 6) refers to a device that is associated with a user account of a transaction ledger. Typically, a user would be associated to a single user account, however artisans of ordinary skill in the related arts given the contents of the present disclosure will readily appreciate that a user may have multiple user accounts. For example, a person may have a work account and a family account. In other words, a user could elect to split their bargaining collateral into multiple accounts within a ledger.

In one specific example, a user (human driver) may drive a vehicle with a license plate, vehicle identification number (VIN), or another unique vehicle identifier. In this case, the vehicle's activity is associated with the user account regardless of the driver identity e.g., a parent or teenager. In another example, a user may be associated with an electronic identity that is managed by an integrated navigation computer of a smart car and/or a handheld smart phone application; such electronic identities may be particularly useful where a person may login to their account across multiple vehicles (e.g., rental cars, etc.) Electronic devices may also be associated with another user identification service that provides authentication/authorization services; examples of such user identifiers include without limitation e.g., IMEI (International Mobile Equipment Identifier (ID)), MEID (Mobile Equipment ID), ICCID (Integrated Circuit Card ID), SEID (Secure Element ID), eUICC issuer ID (EID), etc.

### Functional Description of Communication Network

As used herein, a “communication network” (e.g., communication networks 1000 and 1050 of FIG. 6) refers to an arrangement of logical nodes that enables data communication between endpoints (an endpoint is also a logical node). Each node of the communication network may be addressable by other nodes; typically, a unit of data (a data packet) may be traverse across multiple nodes in “hops” (a segment between two nodes). Functionally, the communication network enables active participants (e.g., fleet devices and/or user devices) to communicate with the transaction ledger. In some implementations, the communication network may also enable active participants to discover and/or communicate with nearby participants.

While the present disclosure discusses the communication network's role for fleet devices, user devices, and transaction ledgers, other systems may additionally connect other network endpoints. For example, some fleet devices may also use the communication network to receive instruction from a control entity. In other examples, the fleet devices, user devices, and/or transaction ledgers may communicate with regulatory and/or enforcement entities.

In most practical applications, a communication network may be composed of sub-networks that are designed for specific applications. While peer nodes must communicate with one another using a shared protocol, translation may occur between different sub-networks in accordance with their specific capabilities. Various embodiments of the present disclosure advantageously leverage certain benefits of their constituent sub-networks. For example, a communication network may incorporate a “last mile” cellular network to provide widespread geographic coverage for fleet devices and user devices, however the backhaul network may use generic Internet protocols to provide cost-effective data communication over long distances.

### Functional Description of Transaction Ledger

As used herein, a “transaction ledger” (e.g., transaction ledger 1100 of FIG. 6) refers to one or more logical nodes that record reconcile transactions between participants' accounts. The participants may be actively involved in recording transactions (so-called “active participants”) or passively involved in transactions (so-called “passive participants”).

In some embodiments, the transaction ledger may be controlled under a centralized authority, in other embodiments, the transaction ledger may be distributed across multiple entities. As but one example, a shipping service or ride-share service may use a private transaction ledger to track its interactions with other participants. In another example, a semi-distributed transaction ledger may be controlled by its members (e.g., one or more corporate entities, etc.) A fully distributed transaction ledger may be used for a completely de-centralized management (similar to the method that cryptocurrencies are tracked and managed using a block chain, circa 2022)

For a variety of different reasons, access to the ledger may entail multiple different levels of privilege. Privileges may specify which parties that can access the records, the type of access, security and/or privacy countermeasures, etc. Different jurisdictions may have different views on privacy; for example, some jurisdictions may require that participants “opt-in” to participation, other jurisdictions may allow passive participants to “opt-out” of participation.

Some implementations may enable/disable various privileged access types. For example, some entities may be allowed full access to the transaction history (to read, write, modify, etc.) Other entities may only be allowed limited access to the transaction record (e.g., to view just their transactions, etc.) While most transactions maybe recorded without conflict; participants may need to e.g., reconcile conflicting transactions, lodge complaints, dispute transactions, etc. In some cases, adjudication may also require external enforcement (e.g., regulatory and/or enforcement entities); in these cases, the transaction ledger may be referenced for restitution, compensation, and/or other remedies.

### Overview of Fleet Device

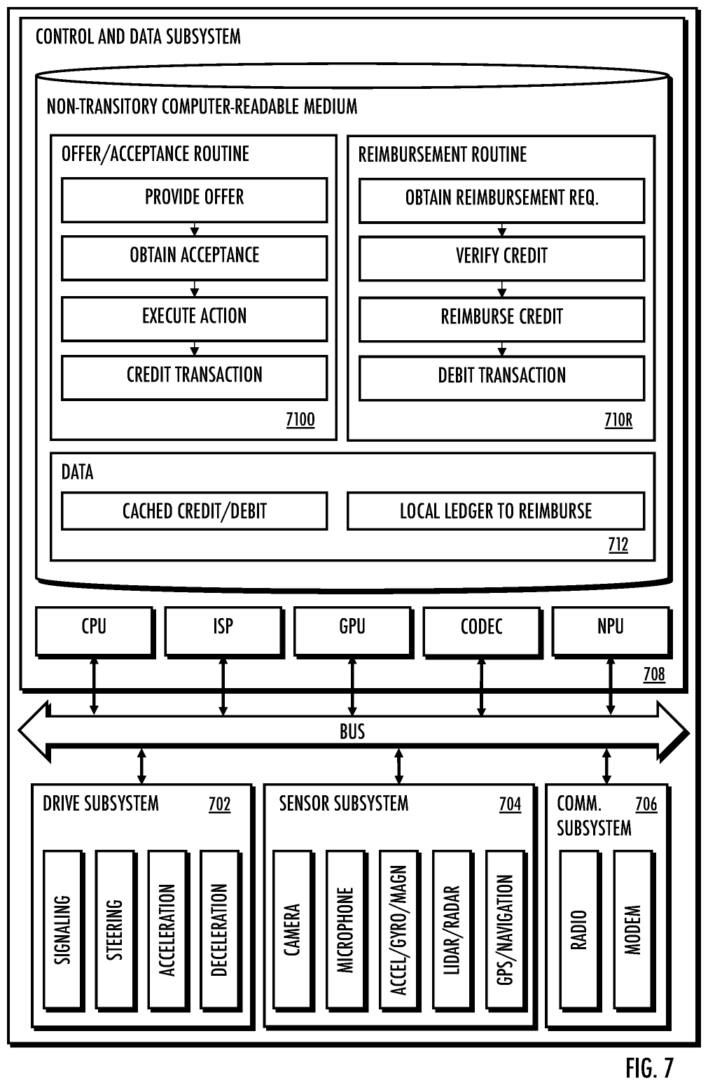

FIG. 7 is a logical block diagram of an exemplary fleet device 700 (e.g., fleet devices 700 of FIG. 6). The fleet device 700 includes: a drive subsystem 702, a sensor subsystem 704, a communication subsystem 706, a control and data subsystem 708, and a bus to enable data transfer. The following discussion provides a specific discussion of the internal operations, design considerations, and/or alternatives, for each subsystem of the exemplary fleet device 700.

### Fleet Device: Drive Subsystem

In one exemplary embodiment, the fleet device 700 is an integrated navigation computer that has been permanently mounted within a vehicle chassis. While the following implementation is discussed in the context of wheeled vehicles that may be driven over terrain, analogous functionality may be substituted for aircraft, watercraft, and/or spacecraft (e.g., drones, planes, ships, boats, etc.) by artisans of ordinary skill in the related arts, given the contents of the present disclosure.

As a brief aside, the vehicle chassis commonly includes the electrical and mechanical drive subsystems necessary to e.g.: convey driver intent (signaling), guide the vehicle motion (steering), propel the vehicle (acceleration), slow/stop the vehicle (deceleration). In some variants, there may also be components that smooth vibrations (suspension). Typically, a motor vehicle chassis includes the following major components: a frame (and/or body units/panels), engine (and/or motors), transmission mechanism, signaling mechanisms, steering mechanism, suspension system, wheels, tires, and brakes. Functionally, the vehicle chassis supports the vehicle payload, withstands acceleration/deceleration forces and torques, absorbs stresses due to steering and/or motion over surfaces. Vehicle chassis often include, without limitation, motorcycle, passenger car, truck, van, semi-trailer truck, bus, and/or train.

In other embodiments, the fleet device 700 may be embodied as electronics that are removably mounted (or semi-permanently mounted) to the vehicle chassis. For example, a smart phone running a fleet application may be used by a human driver to provide human-driven fleet services. In such implementations, the human driver maneuvers the vehicle based on the fleet device's instructions. For example, a human driver may use a map application to instruct their whereabouts and/or route. The map application may include driving instruction as audible notifications and/or visual messaging (e.g., “red sedan, 9HAW270, has agreed to let you in”, etc.)—responsively, the human driver would control signaling, steering, acceleration, and/or deceleration of the vehicle to effectuate the instruction.

As shown in FIG. 7, the drive subsystem 702 of the fleet device 700 interfaces to the electrical and mechanical drive subsystems of the vehicle for cooperative bargaining signaling. As previously alluded to, cooperative bargaining may be implemented with binary signaling (“accept”, “reject”). Consequently, in one embodiment, the fleet device may re-purpose pre-existing signaling apparatus for simple signaling. Pre-existing signals may include, left turn signal, right turn signal, head lights, brake lights, fog lamps, daytime running lamps, hazard lights, and/or any other vehicle lights. For example, pre-existing turn signals could be used to indicate an offer to merge, and brake lights could be used to indicate an acceptance.

More complex signaling may be used to provide additional flexibility and/or capabilities. In some cases, the fleet device may have specialized signaling apparatus for cooperative bargaining. Signaling may be visual (lighting), audible (sound), textual, and/or configurable. Specialized signaling may include different colors/pitch, blink/rhythm, text and/or symbols. As one specific example, some implementations may use uniquely colored lights to draw attention and assist with identification. A spectrum of colors or a blinker frequency may be used to indicate relative importance (e.g., fast blinking red may be very urgent, slow-blinking green may be non-urgent). Audible notifications may be used in daytime, or situations of low visibility (fog). Wireless notifications may be used to convey text and/or emoticon-based messages and/or other information.

Signaling subsystem implementations may trade-off different design considerations. For example, simple signaling may be universally implemented over a large variety of different vehicle modalities at minimal additional cost—this may simplify integration and/or improve communication with the human population of drivers. More complex signaling may allow for flexibility and/or increase the utility of signaling. Increased utility may allow for sophisticated prioritization schemes and/or overall system-wide efficiencies. As but one such example, text messaging may be used to allow virtualized priority queuing even at great distances—e.g., vehicles may be notified miles in advance where to enter the queue for their relative priority (rather than in first-in-first-out ordering).

Referring back to FIG. 7, the drive subsystem 702 of the fleet device 700 interfaces to the electrical and mechanical drive subsystems of the vehicle to execute driving maneuvers (steering, acceleration, deceleration, etc.) In some embodiments, the techniques described herein may be directly incorporated with existing self-driving vehicle algorithms (e.g., see the requirements for SAE Level 2-5 in the Taxonomy and Definition for Terms Related to Driving Automation Systems for On-Road Motor Vehicles, and summarized in Table 2 above).

The techniques described herein may reduce the ambiguity of certain driving situations. As a brief aside, many self-driving algorithms are pre-seeded with expected driving behaviors modeled after large swathes of the human population. In practical usage scenarios, each human driver has idiosyncratic driving behaviors that can add ambiguity. For example, most vehicles can stop (60-0 mph) within 120-140 ft, however, most drivers keep a safety cushion that is much larger (nearly double), to account for reaction time. However, using explicit signaling and cooperative bargaining may reduce ambiguity and allow the self-driving algorithms to use more decisive driving tactics that focus on e.g., fuel conservation, machine limitations, etc. For example, a self-driving vehicle may be able to execute faster, more efficient merges by decreasing turn times and acceleration curves. Similarly, reaction times and/or safety cushions for deceleration can be reduced. More generally, the techniques described throughout may be used to improve vehicle performance by adjusting the drive subsystem's default behaviors for steering, acceleration, deceleration, etc.

### Fleet Device: Sensor Subsystem

The sensor subsystem 704 of the fleet device 700 may use internal sensors, and/or interface to the electrical and mechanical sensor subsystems of the vehicle, for environmental detection. The illustrated sensor subsystem includes: a camera sensor, a microphone, an accelerometer/gyroscope/magnetometer (also referred to as an inertial measurement unit (IMU)), LiDAR/RADAR, and/or Global Positioning System (GPS)/navigation system. In some embodiments, the sensor subsystem is an integral part of the self-driving vehicle operation (e.g., see the requirements for SAE Level 3-5 in the Taxonomy and Definition for Terms Related to Driving Automation Systems for On-Road Motor Vehicles, and summarized in Table 2 above). In other embodiments, the sensor subsystem may be augmented by external devices and/or removably attached components (e.g., smart phones, after market sensors, etc.) The following sections provide detailed descriptions of the individual sensor subsystems.

A camera lens bends (distorts) light to focus on the camera sensor. In one specific implementation, the camera sensor senses light (luminance) via photoelectric sensors (e.g., CMOS sensors). A color filter array (CFA) value provides a color (chrominance) that is associated with each sensor. The combination of each luminance and chrominance value provides a mosaic of discrete red, green, blue value/positions, that may be “demosaiced” to recover a numeric tuple (RGB, CMYK, YUV, YCrCb, etc.) for each pixel of an image. Since self-driving vehicles operate on direct raw data from the image sensor, many cameras use a RCCC (Red Clear Clear Clear) color filter array which provides a higher light intensity than the RGB color filter array used in most imaging cameras.

During operation, self-driving vehicles make use of multiple camera systems to assess the driving environment. Most cameras capture two-dimensional (2D) images; three-dimensional (3D) imagery may require stitching multiple camera images together. 3D imagery is computationally expensive but offers depth information which is often critical for self-driving applications. Since self-driving vehicles rely on visual input for driving decisions, both 2-D and 3-D camera systems may require at least: 130 decibels of dynamic range, signal-to-noise-ratio (SNR) of 1 for 1 mlx (millilux) illumination, and 30 fps capture rates. These capabilities may be necessary to deliver a clear image under a wide range of environments (e.g., even with direct sunlight shining into the lens, etc.).

In one exemplary embodiment, the self-driving vehicle may have one or more primary forward-facing cameras to capture the driving perspective. These cameras may be focused on medium and high range perspectives e.g., 100 and 300 yards. Medium range cameras capture cross-traffic, pedestrians, emergency braking in the car ahead, as well as lane and signal light detection. High-range cameras are used for traffic sign recognition, video-based distance control, and road guidance. In one such implementation, the medium range cameras have a horizontal field of view (FOV) of 70° to 120°; long range cameras may use a FOV of approximately 35° and have multiple aperture settings.

In addition, four or more cameras may be used to capture the immediate surroundings of the vehicle; for example, a secondary front camera captures a view directly below the hood, a rear camera captures the rear view, and side cameras capture the left and right sides, respectively. Typically, these images may be stitched together to give a 360° environment view. To reduce both camera components and stitching complexity, most implementations use a wide FOV cameras (so-called fisheye lenses provide between 120° and 195°).

In one exemplary embodiment, the forward-facing cameras may be used to identify signaling from other vehicles ahead. For example, a self-driving vehicle can identify other drivers ahead, that would be willing to let-in the self-driving vehicle. The 360° environment view may be used to determine when the other driver has created enough space to lane change. The secondary front camera and rear camera may be used to verify license plates, car models, and/or other unique indicia after a successful acceptance and/or reimbursement—these images may be included as part of the transaction record for subsequent reconciliation, etc.

In some embodiments, a primary rear-facing camera may be used to identify signaling from other vehicles behind (e.g., participants that want to be let-in). For example, a self-driving vehicle can use a rear camera that provides a rear view at medium and high range perspectives e.g., 100 and 300 yards. This may be particularly helpful to see reimbursement requests at a significant distance.

More generally, however, any camera lens or set of camera lenses may be substituted with equal success for any of the foregoing tasks; including e.g., narrow field-of-view (30° to 90°) and/or stitched variants (e.g., 360° panoramas). While the foregoing techniques are described in the context of perceptible light, the techniques maybe applied to other electromagnetic (EM) radiation capture and focus apparatus including without limitation: infrared, ultraviolet, and/or X-ray, etc.

The aforementioned embodiments use explicit visual signaling and/or identification that are designed to minimize ambiguity; for example, signaling with turn signals/brake lights can be detected with low quality cameras, even under low visibility conditions. License plates often use reflective backing and are designed for legibility (at “following” ranges). In other words, lower quality cameras and/or vision processing may be used to accomplish similar results to pre-existing implementations. For example, the front facing camera may use a narrower FOV at higher frame rates, etc. (focused on road conditions directly in-front of the vehicle), whereas the 360° periphery cameras may use lower resolution and/or frame rates to identify cooperative participants. In some cases, the periphery cameras may use low quality stitching and/or no-stitch, to further reduce processing complexity. In many cases, this may be particularly useful for embedded real-time scheduling and/or cost reductions.

The inertial measurement unit (IMU) includes one or more accelerometers, gyroscopes, and/or magnetometers. Typically, an accelerometer uses a damped mass and spring assembly to measure proper acceleration (i.e., acceleration in its own instantaneous rest frame). In many cases, accelerometers may have a variable frequency response. Most gyroscopes use a rotating mass to measure angular velocity; a MEMS (microelectromechanical) gyroscope may use a pendulum mass to achieve a similar effect by measuring the pendulum's perturbations. Most magnetometers use a ferromagnetic element to measure the vector and strength of a magnetic field; other magnetometers may rely on induced currents and/or pickup coils. The IMU uses the acceleration, angular velocity, and/or magnetic information to calculate quaternions that define the relative motion of an object in four-dimensional (4D) space. Quaternions can be efficiently computed and used to directly determine velocity (both vehicle direction and speed), independent of wheel rotation.

In one exemplary embodiment, IMU information may be used to augment other sensors to improve robust detection of the vehicle's motion. This may be especially useful where the fleet device is only partially integrated with the vehicle chassis (e.g., removably mounted or semi-permanently mounted). For example, the IMU information may be used, in conjunction with visual confirmation and/or RADAR/LiDAR input, to confirm that a fleet device has successfully initiated, or completed, a lane change. Additionally, IMU data may be useful to e.g., reconcile conflicting transactions, lodge complaints, dispute transactions, etc. For example, a human-driven vehicle may not provide enough space at speed, to allow a self-driving vehicle to enter safely. This may be difficult to infer from other information (e.g., visual data and/or RADAR information for two vehicles at high speed may only show a relative difference in speed).

More generally, however, any scheme for detecting vehicle velocity (direction and speed) maybe substituted with equal success for any of the foregoing tasks. Other useful information may include speedometer, tachometer (RPM), and/or compass measurements. While the foregoing techniques are described in the context of an inertial measurement unit (IMU) that provides quaternion vectors, artisans of ordinary skill in the related arts will readily appreciate that raw data (acceleration, rotation, magnetic field) and any of their derivatives may be substituted with equal success.

Radio detection and ranging (RADAR) uses radio waves to detect nearby objects. A RADAR transmitter emits a radio wave; the radio wave bounces off nearby objects and is received back at the RADAR receiver. The reflections are processed to determine the distance, angle, and velocity of the objects. Self-driving vehicles use RADAR during blind spot detection, lane and lane-changes, rear end collision avoidance, parking assist, cross-traffic monitoring, emergency braking, and automatic distance control. Most RADAR systems are based on either 24 GHz or 77 GHz electromagnetic waves. 77 GHz RADAR provides higher accuracy and smaller antenna size, however regulatory requirements may limit usage (e.g., global frequency specifications only allow 1 GHz bandwidth at 77 GHz frequency).

Light detection and ranging (LiDAR) is similar to RADAR, however LiDAR uses directed lasers (collimated light) instead of radio waves. Most LiDAR (circa 2022) uses electromagnetic radiation between 600-1000 nm (500 THz-300 THz). For comparison, standard RADAR has a resolution of several meters at loom distance; in contrast, LiDAR can provide resolution down to a few centimeters at the same distance. Current LiDAR designs (circa 2022) use MEMS micromirrors to transmit a collimated laser according to a scan-line pattern. The manufacturing complexity of MEMS micromirrors for precision, service life, adjustability, and reliability contribute to high costs and relatively low adoption compared to RADAR (circa 2022). Nonetheless, LiDAR may replace RADAR over time as manufacturing techniques improve and device requirements increase.

In one exemplary embodiment, RADAR and/or LiDAR information may be used to augment visual information to improve object detection. As previously noted, the RADAR/LiDAR information may be used, in conjunction with visual confirmation and/or IMU input, to confirm that a fleet device has successfully initiated, or completed, a lane change. Additionally, RADAR and/or LiDAR data maybe useful to e.g., assist in situations where visibility is low (fog) and/or reduce image processing burdens.

Global Positioning System (GPS) is a satellite-based radio navigation system that allows a user device to triangulate its location anywhere in the world. Each GPS satellite carries very stable atomic clocks that are synchronized with one another and with ground clocks. Any drift from time maintained on the ground is corrected daily. In the same manner, the satellite locations are known with great precision. The satellites continuously broadcast their current position.

During operation, GPS receivers attempt to demodulate GPS satellite broadcasts. Since the speed of radio waves is constant and independent of the satellite speed, the time delay between when the satellite transmits a signal and the receiver receives it is proportional to the distance from the satellite to the receiver. Once received, a GPS receiver can triangulate its own four-dimensional position in spacetime based on data received from multiple GPS satellites. At a minimum, four satellites must be in view of the receiver for it to compute four unknown quantities (three position coordinates and the deviation of its own clock from satellite time). In so-called “assisted GPS” implementations, ephemeris data may be downloaded from cellular networks to reduce processing complexity (e.g., the receiver can reduce its search window).

In one exemplary embodiment, GPS and/or route information may be used to identify the geographic area that a vehicle has traveled in and/or will pass through. In some cases, this may allow for better predictions as to which participants the fleet vehicle may encounter. As previously noted, improving the likelihood of possible reimbursements may result in better exchange rates and/or more frequent cooperation. Reducing the size of the local ledger may also reduce memory cost and/or computational search time. Furthermore, GPS and/or route information may also be used to e.g., reconcile conflicting transactions, lodge complaints, dispute transactions, etc. For example, conflicting records may analyze travel and/or position information to investigate potentially fraudulent claims. Additionally, GPS and/or route information may also be provided to law enforcement to penalize particularly perverse and/or dangerous behavior (such as cutting across multiple lanes of traffic to cut into an open spot, etc.)

### Fleet Device: Communication Subsystem

The communication subsystem 706 of the fleet device 700 may include one or more radios and/or modems. While the following discussion is presented in the context of 5G cellular networks, artisans of ordinary skill in the related arts will readily appreciate that future communication subsystems may use higher generation technologies (e.g., 6^{th} Generation (6G), etc.) Additionally, some self-driving applications may operate within controlled environments and/or tasks (e.g. see the requirements for SAE Level 4 in the Taxonomy and Definition for Terms Related to Driving Automation Systems for On-Road Motor Vehicles, and summarized in Table 2 above). In such situations, the last mile connectivity may be provided via Wi-Fi or another short-range wireless communication protocol. Still other network connectivity solutions may be substituted with equal success, by artisans of ordinary skill given the contents of the present disclosure.

In one exemplary embodiment, the radio and modem are configured to communicate over the “last mile” using a 5^{th} Generation (5G) cellular network. As used herein, the term “modem” refers to a modulator-demodulator for converting computer data (digital) into a waveform (baseband analog). The term “radio” refers to the front end portion of the modem that upconverts and/or downconverts the baseband analog waveform to/from the RF carrier frequency. Here, the “last mile” metaphorically refers to the final leg of the telecommunication network, rather than an actual distance.

In one exemplary embodiment, the fleet device may connect to the cellular network with best effort and/or low data requirements (e.g., via 5G enhanced Mobile Broadband (eMBB) or massive Machine Type Communications (mMTC) network slices discussed in greater detail below) to communicate transaction data with the transaction ledger. In some implementations, the communication network may also enable the fleet device to discover and/or communicate with nearby participants with best effort and/or low data requirements. More generally, the techniques described throughout may be performed with little (or no) network connectivity; locally cached data may be used for offer/acceptance/reimbursements, and ledger updates do not need real-time treatment. As a practical matter, the fleet device can minimize its reliance on “mission critical” network connectivity (e.g., ultra-reliable low latency communications (URLLC) network slices discussed in greater detail below) which improves overall network utilization. Additionally, since real-time network operation usually requires the processor to service network data in real-time to minimize link latency, the fleet device's resources may also improve processor scheduling, task execution, and/or overall processor utilization, under best effort delivery.

### Fleet Device: Control and Data Subsystem

The control and data subsystem 708 controls the fleet device's operation and stores and processes transaction data. In one exemplary embodiment, the control and data subsystem uses processing units that execute instructions stored in a non-transitory computer-readable medium (memory). More generally however, other forms of control and/or data may be substituted with equal success, including e.g., neural network processors, dedicated logic (field programmable gate arrays (FPGAs), application specific integrated circuits (ASICs)), and/or other software, firmware, and/or hardware implementations. As shown in FIG. 7, the control and data subsystem may include one or more of: a central processing unit (CPU), an image signal processor (ISP), a graphics processing unit (GPU), a codec, a neural network processor (NPU), and a non-transitory computer-readable medium that stores program instructions and/or data.

### Processor and Memory Implementations

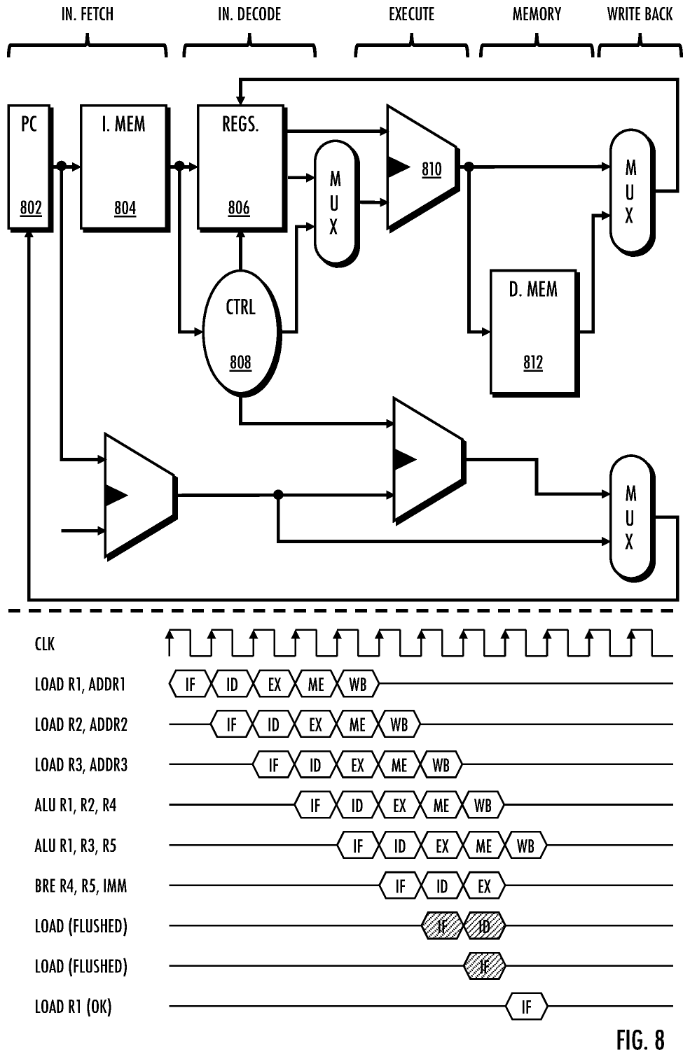

As a brief aside, FIG. 8 is a logical block diagram of a basic processor architecture useful to illustrate various aspects of processor design that may be relevant to the techniques described throughout. Artisans of ordinary skill in the related arts will readily appreciate that the techniques described throughout are not limited to the basic processor architecture and that more complex processor architectures may be substituted with equal success. Most processor architectures implement e.g., larger pipeline depths, parallel processing, more sophisticated execution logic, multi-cycle execution, and/or power management, etc.

At each clock cycle, instructions propagate through a “pipeline” of processing stages; the illustrated basic processor architecture uses: an instruction fetch (IF), an instruction decode (ID), an operation execution (EX), a memory access (ME), and a write back (WB). During the instruction fetch stage, an instruction is fetched from the instruction memory 804 based on the current program counter 802. The fetched instruction is provided to the instruction decode stage, where a control unit 808 determines the input and output data structures and the operations to be performed. For example, the illustrated instruction LOAD R1, ADDR1 instructs the execution stage to “load” a first register

R1 of registers 806 with the data stored at address ADDR1. As another example, ALU R1, R2, R4 instructs the arithmetic logic unit (ALU) 810 at the execution stage to perform an “arithmetic operation” with the contents of the first register R1 and the second register R2, then store the result within a third register R4. In some cases, the result of the operation may be written to a data memory 812 and/or written back to the registers or program counter.

As shown in FIG. 8, certain instructions may create a non-sequential access. For example, BRE R4, R5, IMM instructs the execution stage to “branch when equal”—in other words, the execution stage will change the program counter to the immediate value IMM, when the contents of registers R4 and R5 are equal. Notably, non-sequential access requires the pipeline to flush earlier stages of the pipeline which have been queued, but not yet executed. For example, in the illustrated example, two in-flight instructions are flushed by the conditional branch.

As a practical matter, different processor architectures attempt to optimize their designs for their most likely usages. More specialized logic can often result in much higher performance (e.g., by avoiding unnecessary operations, memory accesses, and/or conditional branching). For example, a general-purpose CPU (such as shown in FIG. 7) may be primarily used to control device operation and/or perform tasks of arbitrary complexity/best-effort. CPU operations may include, without limitation: operating system (OS) functionality (power management, UX), memory management, etc. Typically, such CPUs are selected to have relatively short pipelining, longer words (e.g., 32-bit, 64-bit, and/or super-scalar words), and/or addressable space that can access both local cache memory and/or pages of system virtual memory. More directly, a CPU may often switch between tasks, and must account for branch disruption and/or arbitrary memory access.

In contrast, the image signal processor (ISP) performs many of the same tasks repeatedly over a well-defined data structure. Specifically, the ISP maps captured camera sensor data to a color space. ISP operations often include, without limitation: demosaicing, color correction, white balance, and/or autoexposure. Most of these actions may be done with scalar vector-matrix multiplication. Raw image data has a defined size and capture rate (for video) and the ISP operations are performed identically for each pixel; as a result, ISP designs are heavily pipelined (and seldom branch), may incorporate specialized vector-matrix logic, and often rely on reduced addressable space and other task-specific optimizations. ISP designs only need to keep up with the camera sensor output to stay within the real-time budget; thus, ISPs more often benefit from larger register/data structures and do not need parallelization.

Much like the ISP, the GPU is primarily used to modify image data and may be heavily pipelined (seldom branches) and may incorporate specialized vector-matrix logic. Unlike the ISP however, the GPU often performs image processing acceleration for the CPU, thus the GPU may need to operate on multiple images at a time and/or other image processing tasks of arbitrary complexity. In many cases, GPU tasks may be parallelized and/or constrained by real-time budgets. GPU operations may include, without limitation: stabilization, lens corrections (stitching, warping, stretching), image corrections (shading, blending), noise reduction (filtering, etc.). GPUs may have much larger addressable space that can access both local cache memory and/or pages of system virtual memory. Additionally, a GPU may include multiple parallel cores and load balancing logic to e.g., manage power consumption and/or performance.

The hardware codec converts image data to an encoded data for transfer and/or converts encoded data to image data for playback. Much like ISPs, hardware codecs are often designed according to specific use cases and heavily commoditized. Typical hardware codecs are heavily pipelined, may incorporate discrete cosine transform (DCT) logic (which is used by most compression standards), and often have large internal memories to hold multiple frames of video for motion estimation (spatial and/or temporal). As with ISPs, codecs are often bottlenecked by network connectivity and/or processor bandwidth, thus codecs are seldom parallelized and may have specialized data structures (e.g., registers that are a multiple of an image row width, etc.).

Other processor subsystem implementations may multiply, combine, further subdivide, augment, and/or subsume the foregoing functionalities within these or other processing elements. For example, multiple ISPs may be used to service multiple camera sensors. Similarly, codec functionality may be subsumed with either GPU or CPU operation via software emulation.

### Neural Network and Machine Learning Implementations

Referring back to FIG. 7, the fleet device may include a neural network processor (NPU). Unlike traditional “Turing”-based processor architectures (discussed above), neural network processing emulates a network of connected nodes (also known as “neurons”) that loosely model the neuro-biological functionality found in the human brain. While neural network computing is still in its infancy, such technologies already have great promise for e.g., compute rich, low power, and/or continuous processing applications. NPU solutions have been proposed for a variety of tasks for self-driving vehicles. Within the context of the present disclosure, the NPU may be used to learn the most efficient usage of its bargaining power based on multiple factors. For example, the NPU may consider its own needs, the needs of the fleet, the current traffic situation, the other participants and/or its relative costs and benefits to cooperative bargaining.

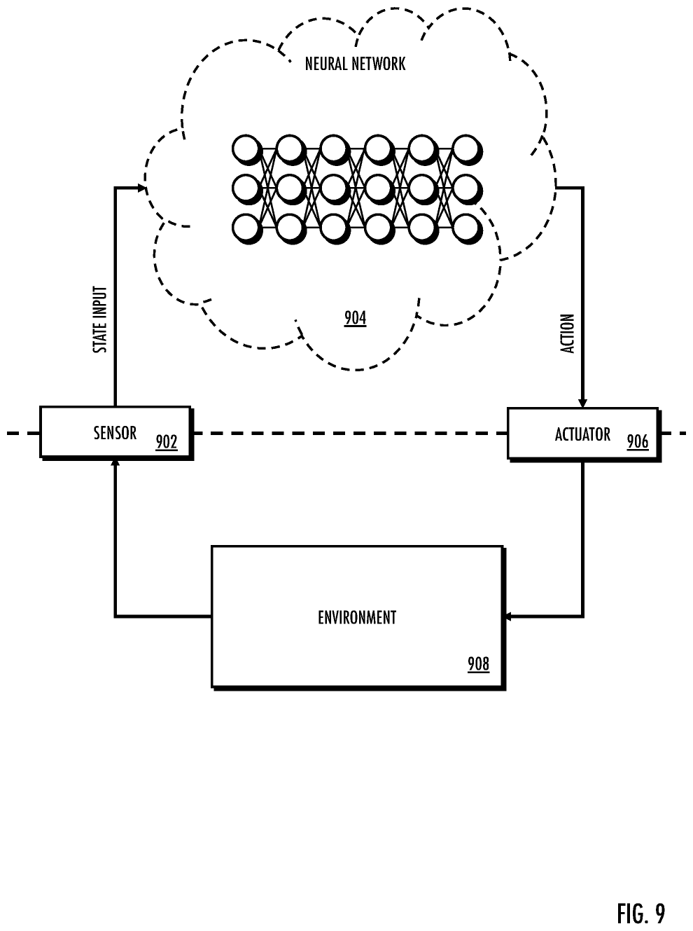

FIG. 9 is a logical block diagram of a neural networking architecture useful to illustrate various aspects of neural network design that are may be relevant to the techniques described throughout. As shown in FIG. 9, the neural network algorithm obtains state input from one or more sensors 902 and then processes the state input with a neural network of processor nodes 904. The neural network of processor nodes 904 generate an action that drives an actuator 906, which affects the environment 908. The environment is then observed to provide the next state input.

Each processor node of the neural network 904 is a computation unit that may have any number of weighted input connections, and any number of weighted output connections. The inputs are combined according to a transfer function to generate the outputs. In one specific embodiment, each processor node of the neural network combines its inputs with a set of coefficients (weights) that amplify or dampen the constituent components of its input data. The input-weight products are summed and then the sum is passed through a node's activation function, to determine the size and magnitude of the output data. “Activated” neurons (processor nodes) generate output data. The output data maybe fed to another neuron (processor node) or result in an action on the environment. Coefficients may be iteratively updated with feedback to amplify inputs that are beneficial, while dampening the inputs that are not.

Many neural network processors emulate the individual neural network nodes as software threads, and large vector-matrix multiply accumulates. A “thread” is the smallest discrete unit of processor utilization that may be scheduled for a core to execute. A thread is characterized by: (i) a set of instructions that is executed by a processor, (ii) a program counter that identifies the current point of execution for the thread, (iii) a stack data structure that temporarily stores thread data, and (iv) registers for storing arguments of opcode execution. Other implementations may use hardware or dedicated logic to implement processor node logic, however neural network processing is still in its infancy (circa 2022) and has not yet become a commoditized semiconductor technology.

As used herein, the term “emulate” and its linguistic derivatives refers to software processes that reproduce the function of an entity based on a processing description. For example, a processor node of a machine learning algorithm may be emulated with “state inputs”, and a “transfer function”, that generate an “action.”

Unlike the Turing-based processor architectures, machine learning algorithms learn a task that is not explicitly described with instructions. In other words, machine learning algorithms seek to create inferences from patterns in data using e.g., statistical models and/or analysis. The inferences may then be used to formulate predicted outputs that can be compared to actual output to generate feedback. Each iteration of inference and feedback is used to improve the underlying statistical models. Since the task is accomplished through dynamic coefficient weighting rather than explicit instructions, machine learning algorithms can change their behavior over time to e.g., improve performance, change tasks, etc.

Typically, machine learning algorithms are “trained” until their predicted outputs match the desired output (to within a threshold similarity). Training may occur “offline” with batches of prepared data or “online” with live data using system pre-processing. Many implementations combine offline and online training to e.g., provide accurate initial performance that adjusts to system-specific considerations over time.

In one exemplary embodiment, a neural network processor (NPU) may be trained to cooperatively bargain with humans in off-line training. Once the NPU has “learned” appropriate behavior, the NPU may be used in real-world scenarios. NPU-based solutions are often more resilient to variations in environment and may behave reasonably even in unexpected circumstances (e.g., similar to a human driver.)

### Other Notable Logic Implementations

Application specific integrated circuits (ASICs) and field-programmable gate arrays (FPGAs) are other “dedicated logic” technologies that can provide suitable control and data processing for a fleet device. These technologies are based on register-transfer logic (RTL) rather than procedural steps. In other words, RTL describes combinatorial logic, sequential gates, and their interconnections (i.e., its structure) rather than instructions for execution. While dedicated logic can enable much higher performance for mature logic (e.g., 50×+ relative to software alternatives), the structure of dedicated logic cannot be altered at run-time and is considerably less flexible than software.

Application specific integrated circuits (ASICs) directly convert RTL descriptions to combinatorial logic and sequential gates. For example, a 2-input combinatorial logic gate (AND, OR, XOR, etc.) may be implemented by physically arranging 4 transistor logic gates, a flip-flop register may be implemented with 12 transistor logic gates. ASIC layouts are physically etched and doped into silicon substrate; once created, the ASIC functionality cannot be modified. Notably, ASIC designs can be incredibly power-efficient and achieve the highest levels of performance. Unfortunately, the manufacture of ASICs is expensive and cannot be modified after fabrication—as a result, ASIC devices are usually only used in very mature (commodity) designs that compete primarily on price rather than functionality.

FPGAs are designed to be programmed “in-the-field” after manufacturing. FPGAs contain an array of look-up-table (LUT) memories (often referred to as programmable logic blocks) that can be used to emulate a logical gate. As but one such example, a 2-input LUT takes two bits of input which address 4 possible memory locations. By storing “1” into the location of 0#b′11 and setting all other locations to be “0” the 2-input LUT emulates an AND gate. Conversely, by storing “0” into the location of 0#b′00 and setting all other locations to be “1” the 2-input LUT emulates an OR gate. In other words, FPGAs implement Boolean logic as memory—any arbitrary logic may be created by interconnecting LUTs (combinatorial logic) to one another along with registers, flip-flops, and/or dedicated memory blocks. LUTs take up substantially more die space than gate-level equivalents; additionally, FPGA-based designs are often only sparsely programmed since the interconnect fabric may limit “fanout.” As a practical matter, an FPGA may offer lower performance than an ASIC (but still better than software equivalents) with substantially larger die size and power consumption. FPGA solutions are often used for limited-run, high performance applications that may evolve over time.

### Fleet Device: Logical Operation

Referring back to FIG. 7, the non-transitory computer-readable medium may be used to store data locally at the fleet device. In one exemplary embodiment, data may be stored as non-transitory symbols (e.g., bits, bytes, words, and/or other data structures.) In one specific implementation, the memory subsystem is realized as one or more physical memory chips (e.g., NAND/NOR flash) that are logically separated into memory data structures. The memory subsystem may be bifurcated into program code (e.g., offer/acceptance routine 710O, and reimbursement routine 710R) and/or program data 712. In some variants, program code and/or program data may be further organized for dedicated and/or collaborative use. For example, the GPU and CPU may share a common memory buffer to facilitate large transfers of data. Similarly, the codec may have a dedicated memory buffer to avoid resource contention.

In one embodiment, the program code includes instructions that when executed by the processor subsystem cause the processor subsystem to perform tasks which may include: calculations, and/or actuation of the drive subsystem 702, sensor subsystem 704, and/or communication subsystem 706. In some embodiments, the program code may be statically stored within the fleet device 700 as firmware. In other embodiments, the program code may be dynamically stored (and changeable) via software updates. In some such variants, software may be subsequently updated by external parties and/or the user, based on various access permissions and procedures.

In one exemplary embodiment, the non-transitory computer-readable medium includes an offer/acceptance routine 710O. When executed by the control and data subsystem, the offer/acceptance routine 710O causes the fleet device to: provide an offer to an other participant; obtain acceptance from the other participant; execute the maneuver; and credit the transaction to the other participant. The following discussion provides a specific discussion of the steps performed during the offer/acceptance routine 710O.

In a first step of the routine 710O, the fleet device provides an offer to an other participant. While the foregoing examples have been described in the context of merging into/out-of traffic, the techniques described throughout may be broadly applied to any unmanaged encounter between two or more parties. Within the context of self-driving vehicles, drivers regularly must regularly determine who has the “right-of-way.” Examples include e.g., merging, four-way stops, roundabouts, steep grades (without a passing lane), etc. As noted above, other applications may include industrial, financial, medical, and/or scientific resource management including e.g., network connectivity, energy usage, and/or water distribution.

Conceptually, the fleet device seeks to form a contract with the other participant. In other words, the fleet device “offers” a set of terms, the other participant may “accept” the terms of the contract. “Bilateral” contracts obligate both the offeror and the offeree (e.g., to “let-in”, in exchange for a credit). In contrast, “unilateral” contracts are formed at performance. so-called unilateral contracts only obligate the offeror (the offeree cannot breach). Once the contract has been formed, failure to perform results in a breach. In some implementations, breach may require remedy; in other implementations, breach is preferred over e.g., an accident. As a practical matter, the terms of the contract may be simple and understood in advance to encourage human-machine-negotiation.

In one embodiment, the offer is provided via the signaling subsystem. In one specific implementation, the offer may be signaled using pre-existing signaling modalities. For example, pre-existing turn signals could be used to indicate an offer to merge, and brake lights could be used to indicate an acceptance. In other implementations, the offer may be signaled using different colors/pitch, blink/rhythm, text and/or symbols. In other embodiments, the offer is provided via the communication subsystem. In one specific implementation, the offer may be signaled using text messaging and/or application notifications.

In one embodiment, the offer identifies a token of value to be exchanged for a specified action. For example, a token may be a digital credit to an account of a transaction ledger. The digital credit may be offered as a one-for-one exchange i.e., for letting-in a self-driving vehicle now, the participant may be let-in by any other fleet device later. In some variants, the token may have a fixed value; in other variants, the token may have a variable value. The value of the token may be non-monetary, monetary, or some hybrid thereof. A variety of different considerations may be used to determine value and/or exchanges. For example, certain fleets may have more (or less) bargaining power and offer commensurate exchange rates. In another example, a fleet vehicle may need to increase its exchange rate based on its next best alternative (e.g., driving to the next exit and circling back).

In one embodiment, the offer may be provided to any participant. For example, an audible/visual signal may be observed by anyone (e.g., broadcast). In other embodiments, the offer may be provided to specific participants. For example, text messaging or in-application notifications may be used to limit the offers to only specific participants. In some cases, the offer may be provided far in advance. As one such example, a self-driving vehicle may know its route in advance and send requests to locations of high traffic a few minutes in advance.

In some embodiments, offers may be extended to participants according to a priority scheme. Some participants may become “early adopters” that are more comfortable with cooperative bargaining; over time, this may result in a much higher match percentage and (potentially) favorable exchange rates. Similarly, some participants may be undesirable and de-prioritized. For example, participants that frequently breach agreements may be ignored in favor of other takers.

In a second step of the routine 710O, the fleet device obtains acceptance from the other participant. In one embodiment, the acceptance is detected via the sensor subsystem. In one specific implementation, the acceptance may be captured using cameras and/or microphones. Different cameras (and/or microphones) may be used depending on the relative speed and/or desired merge location; for example, at high speed, the fleet device may use its primary forward-facing cameras to look for takers whereas at low speed/standstill, the fleet device may use its 360° environment view. In some cases, the fleet device may use computer vision algorithms to search for flashing brake lights, or audio processing algorithms to identify a short “beep” of a horn, indicating an acceptance. In other embodiments, the acceptance is received via the communication subsystem. In one specific implementation, the acceptance may be received using text messaging and/or application notifications.

In one embodiment, the acceptance may be granted on a first-come-first-served basis. In other embodiments, the acceptance may use a bidding scheme to drive up/down exchange rates. For example, the fleet device may take the cheaper offer of multiple accepters; or the fleet device may increase the offer exchange if there is no taker.

In response to successful acceptance and performance of the contract, the fleet device executes the action (third step of the routine 710O). As previously noted, a participant that accepts an offer may also need to take adequate steps to ensure a successful outcome. In the illustrative scenario of a “let-in”, the acceptance of the offer may include making space for the fleet device to safely merge. Other examples of traffic applications may include e.g., ensuring that a self-driving vehicle has enough vehicle clearance to safely turn on a four-way stop or a roundabout, allowing a self-driving vehicle enough space to pass by on a steep grade (without a passing lane), etc. In some cases, the fleet device may document the environment during the exchange. This documentation may be reviewed later to verify that both parties complied with the terms of the deal. In some cases, this footage may also be provided to law enforcement and/or other enforcement mechanisms to penalize particularly perverse and/or dangerous behavior.

While the foregoing examples are presented in the context of non-monetary credits, systems that use monetary (or some equivalent) may require remedies for breach according to restitution, compensation, and/or other such principles. Compensatory remedies may be used to shift the cost of remedy to the breaching party. For example, if a self-driving vehicle attempted to be let-in early at 1 credit, but due to breach could not enter until later at 2 credits, then the breaching party may have 1 credit removed from their account to cover the difference in cost. Restitution type remedies seek to remove the benefit of breach from the breaching party. For example, if a self-driving vehicle initially offered 1 credit, but the same offeree waited until 2 credits were offered, then the breaching party may be capped to the previously offered rate (i.e., 1 credit). In other words, artisans of ordinary skill in the related arts will readily appreciate that a variety of different contract remedies exist to prevent perverse behaviors.

In a fourth step of the routine 710O, the fleet device credits the transaction to the other participant after successful completion. In one embodiment, completion status may be detected via the sensor subsystem (e.g., once the self-driving vehicle has entered the lane, and the offeree's license plate is captured via the rear camera.)

In one implementation, the transaction is documented within a transaction record. The transaction record may be locally cached for bulk upload (or as-requested) to the transaction ledger. In one specific implementation, the transaction record may be uploaded via the communication subsystem, under best effort or background task priority.

As used herein, the term “credit” may be used to describe a token of value, or a transaction associated with the token. Notably, the token of value may be non-monetary or monetary. Value in this context refers to any utility to a participant (e.g., a promise to be let-in later has utility). As used herein, a “credit transaction” refers to an outgoing transfer of a token of value, from one account to another account (e.g., a fleet account transfers a credit out to a user account). a “debit transaction” refers to an incoming transfer from another account (e.g., from a user account into the fleet account).

The transaction record may identify the time, date, and location of the transaction, the parties to the transaction, the terms of the transaction, and subsequent disposition of performance. For vehicle transactions, the location of the transaction may be identified according to e.g., GPS navigation, and/or street address or similar navigation indicia. In some cases, the parties may be identified by e.g., their license plates, make model of vehicle, or another unique vehicle identifier. Other forms of user identification may include electronic identities such as e.g., IMEI (International Mobile Equipment Identifier (ID)), MEID (Mobile Equipment ID), ICCID (Integrated Circuit Card ID), SEID (Secure Element ID), eUICC issuer ID (EID), etc. The disposition of performance may be enumerated values including e.g., success, substantial success, substantial breach, complete breach (failure), etc.

In some embodiments, additional information may be provided to assist with subsequent reconciliation and/or adjudication. Examples of such information may include, e.g., images and/or video footage of the transaction, GPS navigation data, and/or time/date stamps leading up to the transaction. In some implementations, the other participant must also document completion. Two distinct accounts of the same transaction may provide robust transaction information, allow for reconciliation, and/or prevent fraud. More generally, any account of the transaction may be used to assist in reconciliation including, e.g., other nearby fleet vehicles and/or participants.

In one exemplary embodiment, the non-transitory computer-readable medium includes a reimbursement routine 710R. When executed by the control and data subsystem, the reimbursement routine 710R causes the fleet device to: obtain a reimbursement request from an other participant; verify a credit associated with the other participant; responsive to successful verification, reimburse the credit; and debit the transaction from the other participant. The following discussion provides a specific discussion of the steps performed during the reimbursement routine 710R.

In a first step of the routine 710R, the fleet device obtains a reimbursement request from an other participant. In one embodiment, the reimbursement request is detected via the sensor subsystem. In one specific implementation, the reimbursement request may be captured using cameras and/or microphones. Typically, the reimbursement request would be captured in the rear camera. In some variants, the rear cameras may have both a short range (immediate peripheral), medium range (100 yards) and/or high range (300 yards). Most lane merge situations are characterized by significant speed differences; in this case, different cameras may be used depending on the relative speed of the nearby traffic lanes. For example, at large differences in lane speeds, the fleet device may use its primary rear-facing cameras to look for takers up to 300 yards behind. At lower speed differences, the fleet device may use the medium range and/or environmental cameras. In some cases, the fleet device may use computer vision algorithms to search for flashing turn signals indicating a desired merge.

In some embodiments, the reimbursement request may be received via the communication subsystem. In one specific implementation, the reimbursement request may be received using text messaging and/or application notifications. For example, a participant that has previously planned their route may periodically ping other nearby participants to identify potential matches ahead.

Once the fleet device has identified a request for reimbursement, the fleet device identifies the requester's identity. In one such implementation, the fleet device may identify the requester by e.g., computer vision analysis of a license plate and make/model or the requester's identity may be provided via the communication system (e.g., via text or in-application notification). Other variants may use a hybrid approach, e.g., a license plate may identify an account associated with a cellular number to text or other in-application messaging identity; the fleet device may then transact data with the requester via the communication system.

In a second step of the routine 710R, the fleet device verifies a credit associated with the other participant. In one exemplary embodiment, the verification may be performed against the cached local ledger. In simple embodiments, verification may be determined by inspecting the cached local ledger to determine the whether the other participant has credits that can be reimbursed. If the fleet device cannot find an account balance associated, then the fleet device may request an update from the transaction ledger to obtain more recent records. Alternatively, if the fleet device cannot obtain network connectivity, the fleet device may deny the request. Notably, network connection is not required in all transactions (and could be de-prioritized relative to other real-time considerations).

Notably, the cached local ledger may be based on the transaction ledger's previously reconciled account balance. In one embodiment, the fleet device need not detect fraud under real-time constraints. In more robust embodiments, the fleet device may additionally verify other aspects of the requester to ensure that fraud does not occur at the point of transaction; for example, the fleet device may verify that the license plate, make/model, and/or electronic identity are correct for the account. Still other means of verification may be substituted with equal success.

If the credit can be successfully verified, then the fleet device may reimburse the credit (third step of the routine 710R). In one embodiment, the fleet device may acknowledge the reimbursement request via the signaling subsystem. In one specific implementation, the acknowledgement may be signaled using pre-existing signaling modalities. For example, a quick flash of pre-existing brake lights could be used to indicate an acknowledgement. In other embodiments, the acknowledgement is provided via the communication subsystem. In one specific implementation, the acknowledgement may be signaled using text messaging and/or application notifications.

Once acknowledged, the fleet device begins performance and reimburses the credit (third step of the routine 710R). In the illustrative scenario of a “let-in”, the fleet device makes space for the participant to safely merge. Other examples of traffic applications may include e.g., allowing the participant vehicle to proceed first through a four-way stop or roundabout, allowing the participant vehicle enough space to pass by on a steep grade (without a passing lane), etc. In some cases, the fleet device may document the environment during the exchange. This documentation may be reviewed later to verify that both parties complied with the terms of the deal. In some cases, this footage may also be provided to law enforcement and/or other enforcement mechanisms to penalize particularly perverse and/or dangerous behavior.

In a fourth step of the routine 710R, the fleet device debits the transaction to the other participant after successful completion. In one embodiment, completion status may be detected via the sensor subsystem (e.g., once the participant vehicle has entered the lane, via the front camera). As previously noted, the transaction may be documented within a transaction record. The transaction record may be locally cached for bulk upload (or as-requested) to the transaction ledger. In one specific implementation, the transaction record may be uploaded via the communication subsystem, under best effort or background task priority.

### Overview of Communication Network

In one exemplary embodiment, the communication network is composed of a “last mile” cellular network to provide widespread geographic coverage for fleet devices and user devices, and a backhaul network that uses generic Internet protocols to provide cost-effective data communication over long distances. While the following discussion is presented in the context of a “last mile” cellular network and generic Internet protocols for a backhaul network, artisans of ordinary skill in the related arts will readily appreciate that a variety of communication protocols may be substituted with equal success, given the contents of the present disclosure. The following sections provide detailed descriptions of the communication network subsystems.

### Communication Network: “Last Mile” Subsystem

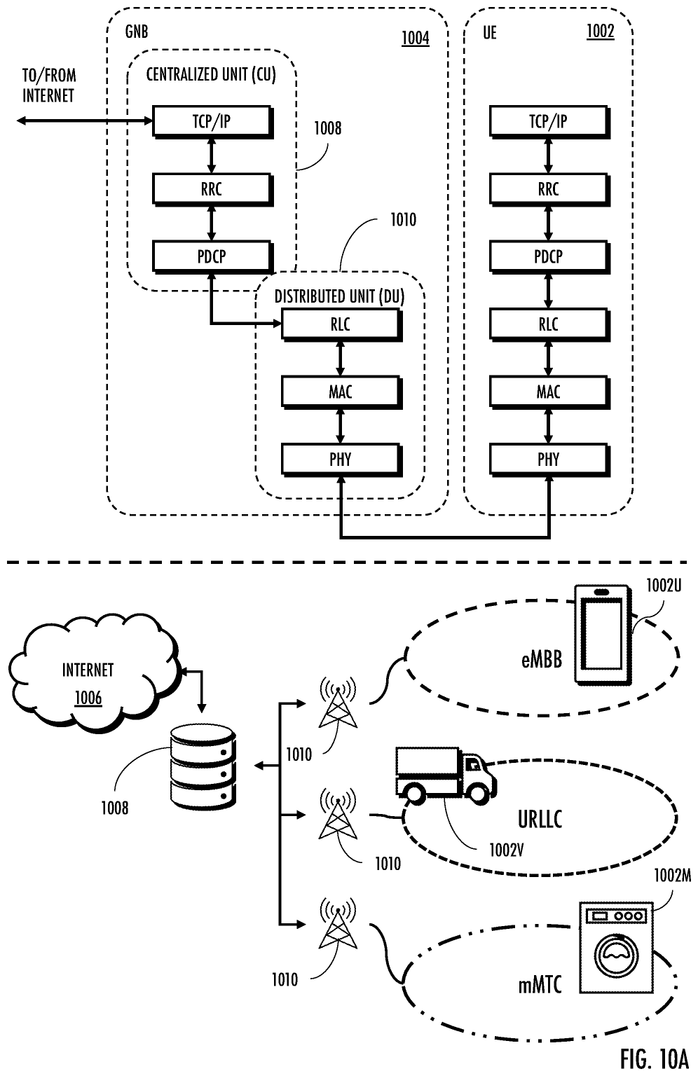

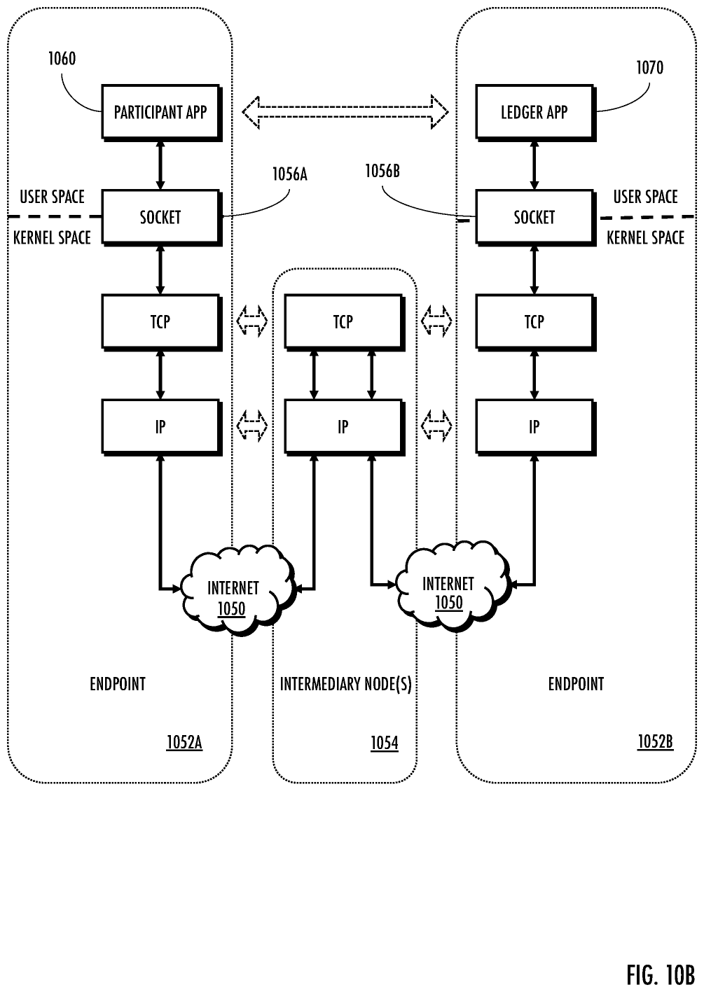

FIG. 10A is a logical block diagram of a cellular communication network 1000, useful in conjunction with various embodiments of the present disclosure. Cellular networks divide the service area into small geographical areas called “cells.” Wireless devices (referred to as user equipment (UE 1002)) communicate with a cellular base station (referred to as a Next Generation Node B (GNB 1004)), over time-frequency resources assigned by the GNB. The GNB is connected to the broader Internet 1006 by optical fiber and/or wireless backhaul connections. The following discussion provides a specific discussion of the internal operations, design considerations, and/or alternatives, for each subsystem of the exemplary last mile portion of the communication network 1000.

As a brief aside, the 5G cellular network standards are promulgated by the 3^{rd} Generation Partnership Project (3GPP) consortium. The 3GPP consortium periodically publishes specifications that define network functionality for the various network components. For example, the 5G system architecture is defined in 3GPP TS 23.501 (System Architecture for the 5G System (5GS), version 17.5.0, published Jun. 15, 2022; incorporated herein by reference in its entirety). As another example, the packet protocol for mobility management and session management is described in 3GPP TS 24.501 (Non-Access-Stratum (NAS) Protocol for 5G System (5G); Stage 3, version 17.5.0, published Jan. 5, 2022; incorporated herein by reference in its entirety).

The 5G communication protocol is subdivided into a protocol stack composed of different layers of protocols. Each layer of the protocol stack communicates with its logical counterpart in another device; for example, the PHY layer of a GNB communicates with the PHY layer of the UE, the MAC layer of a GNB communicates with the MAC layer of the UE, etc. Each layer additionally provides a level of abstraction to the layer above it; for example, the PHY layer handles physical transmission functionality so that the MAC does not need to, etc. As shown, the 5G protocol stack is logically subdivided into: a Physical layer (PHY), a Medium Access Control layer (MAC), a Radio Link Control layer (RLC), a Packet Data Convergence Protocol layer (PDCP), a Radio Resource Connection layer (RRC), and a Transmission Control Protocol/Internet Protocol layer (TCP/IP).

During operation, the UE 1002 and GNB 1004 transmit and receive TCP/IP data packets to/from the Internet. The TCP/IP layer provides the data packets to the PDCP layer. The PDCP layer is responsible for compression and decompression of IP data, in-sequence (and de-duplicated) delivery of IP data, connection time-out, etc. Other PDCP functions may include ciphering and deciphering of data, integrity protection, integrity verification, and other higher layer security protocols. The PDCP layer relies on the RRC layer below it to establish and manage radio resources for a data connection (e.g., a radio bearer).

The RRC layer controls the radio connection. The RRC conveys System Information (SI) that is necessary for mobility management and/or IP connectivity. Additionally, radio bearers are established, maintained, and released via an RRC connection. Other RRC functionality may include key management, establishment, configuration, maintenance, and release of point-to-point radio bearers. The RRC layer relies on the RLC layer to manage data transfer over the radio bearer.

The RLC layer manages data transfer within logical channels of data. The RLC handles error correction, concatenation, segmentation, and reassembly of data according to the logical channels. In some cases, the RLC may also re-segment, reorder, detect duplicates, and/or discard data, etc. The RRC layer relies on the MAC layer to transport the logical channels of data.

The MAC layer maps logical channels to physical transport channels. This entails multiplexing logical channels onto transport blocks (TB) that can be delivered over the physical resources of the network. The MAC layer also manages error correction, dynamic scheduling, and logical channel prioritization. The MAC layer relies on the PHY layer to physically transmit the transport blocks over physical resources.

The PHY layer transfers information from transport channels over the air interface. The PHY layer handles link adaptation, power control, link synchronization, and physical measurements. 5G Cellular networks allow for flexible air interface configuration with a dynamic transmission time interval (TTI) and/or resource block assignments, etc. to achieve different radio link characteristics.

As shown in FIG. 10A, 5G networks further subdivide the GNB into a centralized unit (CU 1008) and one or more distributed units (DUs 1010). DUs are remote radio front ends that may be physically isolated from one another to implement different radio link characteristics within the same GNB. Each DU handles the RLC, MAC, and PHY functionality. The CU processes and aggregates the data streams to recover data packets (e.g., the PDCP, RRC, and TCP/IP functionality). This bifurcated design allows 5G base stations to offer different types of network coverage functionality (referred to as “network slices”). Currently, there are three main application areas for the enhanced capabilities of 5G. They are Enhanced Mobile Broadband (eMBB), Ultra Reliable Low Latency Communications (URLLC), and Massive Machine Type Communications (mMTC).

Enhanced Mobile Broadband (eMBB) uses 5G as a progression from 4G LTE mobile broadband services, with faster connections, higher throughput, and more capacity. eMBB is primarily targeted toward traditional “best effort” delivery (e.g., smart phones such as UE 1002U); in other words, the network does not provide any guarantee that data is delivered or that delivery meets any quality of service. In a best-effort network, all users obtain best-effort service such that the overall network is resource utilization is maximized. In these network slices, network performance characteristics such as network delay and packet loss depend on the current network traffic load and the network hardware capacity. When network load increases, this can lead to packet loss, retransmission, packet delay variation, and further network delay, or even timeout and session disconnect.

Ultra-Reliable Low-Latency Communications (URLLC) network slices are optimized for “mission critical” applications that require uninterrupted and robust data exchange. URLLC uses short-packet data transmissions which are easier to correct and faster to deliver. URLLC was originally envisioned for autonomous vehicles (e.g., self-driving vehicle UE 1002V). More directly, best effort delivery cannot provide the reliability and latency requirements to support the real-time data processing requirements of autonomous vehicles.

Massive Machine-Type Communications (mMTC) was designed for Internet of Things (IoT) and Industrial Internet of Things (IIoT) applications. mMTC provides high connection density and ultra-energy efficiency. mMTC allows a single GNB to service many different UEs with relatively low data requirements; for example, a smart appliance 1002M can provide infrequent logging, metering, and/or monitoring applications.

Communication Network: Backhaul Subsystem

FIG. 10B is a logical block diagram of a backhaul network using generic Internet protocols, useful in conjunction with various embodiments of the present disclosure. Generic IP protocols are widely used across the broader Internet 1050 by optical fiber and/or wireless backhaul connections. The following discussion provides a specific discussion of the internal operations, design considerations, and/or alternatives, for each subsystem of the exemplary backhaul portion of the communication network 1050.

The TCP/IP protocol is based on a protocol stack (discussed above). The Transmission Control Protocol (TCP/IP) handles host-to-host communication, and the Internet Protocol layer provides internetworking between independent networks. As a combined protocol, TCP/IP provides endpoint-to-endpoint data communication across the broader Internet via one or more intermediary nodes. The technical standards underlying the Internet protocol suite and its constituent protocols are maintained by the Internet Engineering Task Force (IETF), and specify how data should be packetized, addressed, transmitted, routed, and received.

As shown in FIG. 10B, a first endpoint 1052A (e.g., fleet device) running a participant application 1060 generates application data for transfer to a second endpoint 1052B (e.g., the transaction ledger) running a ledger application 1070. The application data is packetized into data packets for transmission over the network (which may include one or more intermediary nodes(s) 1054).

A network “socket” is a virtualized internal network endpoint for sending or receiving data at a single node in a computer network. A network socket may be created (“opened”) or destroyed (“closed”) and the manifest of network sockets may be stored as entries in a network resource table which may additionally include reference to various communication protocols (e.g., Transmission Control Protocol (TCP), User Datagram Protocol (UDP), etc.), destination, status, and any other operational processes (kernel extensions) and/or parameters); more generally, network sockets are a form of system resource.

As shown in FIG. 10B, the sockets 1056A and 1056B provide an application programming interface (API) that spans between the user space and the kernel space. An API is a set of clearly defined methods of communication between various software components. An API specification commonly includes, without limitation: routines, data structures, object classes, variables, remote calls and/or any number of other software constructs commonly defined within the computing arts.

As a brief aside, “user space” is a portion of system memory that a processor executes user processes from. User space is relatively freely and dynamically allocated for application software and a few device drivers. The “kernel space” is a portion of memory that a processor executes the kernel from. Kernel space is strictly reserved (usually during the processor boot sequence) for running privileged operating system (O/S) processes, extensions, and most device drivers. For example, each user space process normally runs in a specific memory space (its own “sandbox”) and cannot access the memory of other processes unless explicitly allowed. In contrast, the kernel is the core of a computer's operating system; the kernel can exert complete control over all other processes in the system.

The term “operating system” may refer to software that controls and manages access to hardware. An O/S commonly supports processing functions such as e.g., task scheduling, application execution, input and output management, memory management, security, and peripheral access. As used herein, the term “application” refers to software that can interact with the hardware only via procedures and interfaces offered by the O/S.

The term “privilege” may refer to any access restriction or permission which restricts or permits processor execution. System privileges are commonly used within the computing arts to mitigate the potential damage of a computer security vulnerability. For instance, a properly privileged computer system will prevent malicious software applications from affecting data and task execution associated with other applications and the kernel.

As used herein, the term “in-kernel” and/or “kernel space” may refer to data and/or processes that are stored in, and/or have privilege to access to, the kernel space memory allocations. In contrast, the terms “non-kernel” and/or “user space” refers to data and/or processes that are not privileged to access the kernel space memory allocations. User space represents the address space specific to the user process, whereas non-kernel space represents address space which is not in-kernel, but which may or may not be specific to user processes.

The illustrated sockets 1056A and 1056B provide access to Transmission Control Protocol (TCP) and User Datagram Protocol (UDP). TCP and UDP are various suites of transmission protocols each offering different capabilities and/or functionalities. For example, UDP is a minimal message-oriented encapsulation protocol that provides no guarantees to the upper layer protocol for message delivery and the UDP layer retains no state of UDP messages once sent. UDP is commonly used for real-time, interactive applications (e.g., video chat, voice over IP (VoIP)) where loss of packets is acceptable. In contrast, TCP provides reliable, ordered, and error-checked delivery of data via a retransmission and acknowledgement scheme; TCP is generally used for file transfers where packet loss is unacceptable, and transmission latency is flexible.

As used herein, the term “encapsulation protocol” may refer to modular communication protocols where logically separate functions in the network are abstracted from their underlying structures by inclusion or information hiding within higher level objects. For example, in one exemplary embodiment, UDP provides extra information (ports numbering).

As used herein, the term “transport protocol” may refer to communication protocols that transport data between logical endpoints. A transport protocol may include encapsulation protocol functionality.

Both TCP and UDP are commonly layered over an Internet Protocol (IP) for transmission. IP is a connectionless protocol for use on packet-switched networks that provides a “best effort delivery”. Best effort delivery does not guarantee delivery, nor does it assure proper sequencing or avoidance of duplicate delivery. Generally, these aspects are addressed by TCP or another transport protocol based on UDP.

As a brief aside, consider a web browser that opens a webpage; the web browser application would generally open a number of network sockets to download and/or interact with the various digital assets of the webpage (e.g., for a relatively common place webpage, this could entail instantiating ˜300 sockets). The web browser can write (or read) data to the socket; thereafter, the socket object executes system calls within kernel space to copy (or fetch) data to data structures in the kernel space.

As used herein, the term “domain” may refer to a self-contained memory allocation e.g., user space, kernel space. A “domain crossing” may refer to a transaction, event, or process that “crosses” from one domain to another domain. For example, writing to a network socket from the user space to the kernel space constitutes a domain crossing access.

In this implementation, data that is transacted within the kernel space is stored in memory buffers that are also commonly referred to as “mbufs”. Each mbuf is a fixed size memory buffer that is used generically for transfers (mbufs are used regardless of the calling process e.g., TCP, UDP, etc.). Arbitrarily sized data can be split into multiple mbufs and retrieved one at a time or (depending on system support) retrieved using “scatter-gather” direct memory access (DMA) (“scatter-gather” refers to the process of gathering data from, or scattering data into, a given set of buffers). Each mbuf transfer is parameterized by a single identified mbuf.

Notably, each socket transfer can create multiple mbuf transfers, where each mbuf transfer copies (or fetches) data from a single mbuf at a time. As a further complication, because the socket spans both: (i) user space (limited privileges) and (ii) kernel space (privileged without limitation), the socket transfer must verify that each mbuf copy into/out of kernel space is valid. More directly, the verification process ensures that the data access is not malicious, corrupted, and/or malformed (i.e., that the transfer is appropriately sized and is to/from an appropriate area).

### Overview of Transaction Ledger

In one exemplary embodiment, the transaction ledger is a complete accounting of all transactions between participants. While the following discussion is presented in the context of a blockchain type network, artisans of ordinary skill in the related arts will readily appreciate that a variety of other accounting mechanisms may be substituted with equal success, given the contents of the present disclosure. The following sections provide detailed descriptions of the transaction ledger subsystems.

### Transaction Ledger: Blockchain Operation

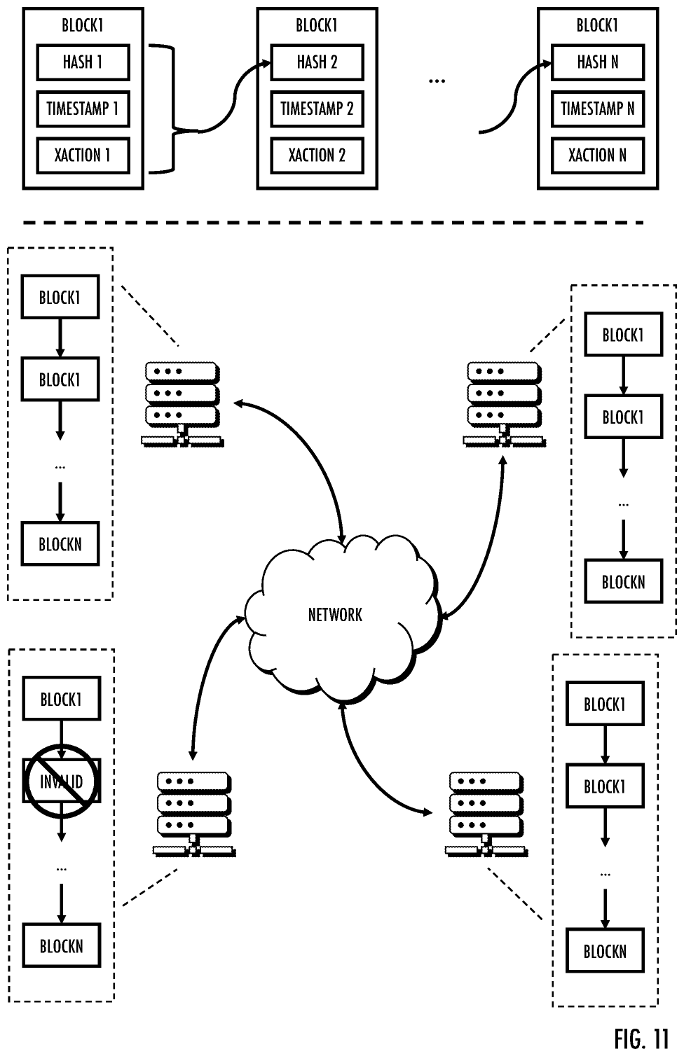

FIG. 11 is a logical block diagram of a blockchain ledger, and a network of nodes that use a distributed blockchain ledger, useful in explaining various aspects of the present disclosure.

A blockchain is a list of records (“blocks”) that are linked together (“chained”) with cryptographic hashes. In one specific implementation, each block contains a cryptographic hash of the previous block, a timestamp, and transaction data. The cryptographic hash is a mathematical algorithm that maps data to a range of hash values; the cryptographic hash is a one-way function i.e., a “message” deterministically maps to only one hash value, and the original message cannot be determined from its hash value. Hashes may have additional desirable properties such as e.g., ease of computation, uniqueness of the hash (e.g., likelihood of messages with the same hash), and/or obfuscation (small changes to the message result in large uncorrelated changes in hash value).

The timestamp and transaction data memorialize a digital transaction. For example, the transaction data may identify two (or more) parties to a digital transaction, a digital asset that was transferred/will be transferred, and/or the transaction time. The timestamp records the time of block publication (which may be different from the transaction time). Other examples of digital transactions may include so-called “smart contracts” (also referred to as “smart K”); smart contracts are software programs that provide contract-like behavior that are partially or fully executed and enforced with machine automation (without human intervention). Smart contracts are often used to avoid trustees/intermediaries and their corresponding frictional costs (e.g., escrow fees, settlement time, etc.). Since the timestamp, transaction data, and previous block's hash value are hashed together, the timestamp proves that the transaction data and previous hash value was present at the block's publication. Smart contracts may not constitute legal agreements; nonetheless, the enforcement mechanism is automated and so external legal enforcement is unnecessary (and, in some cases, impossible).

In distributed ledger applications, blockchain data structures may be used to communicate and validate data transactions without centralized management. As shown in FIG. 11, each node within the network of nodes locally stores a blockchain ledger (“the distributed ledger”). Each node of the network independently audits new transactions; additionally, auditing new transactions is computationally much easier and faster than altering a previous block (and calculating all the resulting downstream changes to hash values). In other words, unlike centralized control, a distributed ledger allows a network of nodes to decentralize governance; no single node controls the distributed ledger, instead the distributed ledger is managed through consensus.

Consider a malicious node that attempts to change the blockchain ledger by substituting a counterfeit ledger that changes an earlier transaction. The other nodes each independently have a local version of the blockchain ledger which has their record of data transactions. Since each node votes in its own self-interest (i.e., it seeks to preserve its version of events), the malicious node's record is quickly discovered. Depending on the network security model, the malicious node may be kicked or otherwise punished. In other words, the collective self-interest of the nodes ensures that no single node (or a minority of nodes working together) can alter the blockchain ledger.

While consensus-based governance protects against a single point-of-attack (and robustly avoids single point-of-failure), it may be susceptible to other types of network attacks that dilute legitimate network participation. For example, a so-called “Sybil” attack occurs where an attacker floods a network with many pseudonym identities (i.e., distinct identities that the attacker controls). Within the context of a majority vote consensus scheme, an attacker may spawn enough pseudonyms to control the majority of the network's nodes and change the distributed ledger at will (this attack is also commonly referred to as a “51% attack”). Other consensus schemes may be susceptible to similar attack methodologies, the foregoing being purely illustrative.

Existing blockchain implementations use “proofs” to defend against Sybil attacks. In most implementations, suitable proof is zero-knowledge i.e., no information other than the proof itself is required for verification by other nodes. So-called “proof-of-work” allows one node (the prover) to show others (the verifiers) that a certain amount of computational effort (work) has been expended. As but another example, so-called “proof-of-stake” allows one node (the prover) to show others (the verifiers) that a certain amount of the voting tokens are possessed (the stake). Other examples of proof include e.g., proof-of-space (an amount of memory), proof-of-authority (an authorized node), proof-of-personhood (a human).

Conceptually, proofs introduce conservation laws into the digital domain. For example, proof-of-work ensures that computational effort is conserved; the proof cannot be multiplied simply by copying the data structure. Similarly, a proof-of-stake ensures that a percentage of stake is owned (and conserved). More directly, existing schemes impose some form of cost on network activity to ensure that attackers cannot dilute legitimate network participation.

While blockchain technologies were first described in decentralized (public) contexts, the technology is not so limited. The blockchain technology has been extended to centralized (private) implementations; in many cases, centralized blockchains may be used to e.g., vest control within a few (trusted) entities, reduce single points of failure, reduce transaction costs, provide faster transaction times, etc. For example, a centralized blockchain is generally much more difficult to successfully attack using pseudonyms. Various other implementations may modify and/or hybridize aspects of blockchain operation to change centralized/decentralized governance. One example of a blockchain network that hybridizes centralized/decentralized governance is the LTO network.

### Transaction Ledger: Ledger Accounting

In one exemplary embodiment, the transaction ledger is a collection of participant accounts for recording transactions. Each account has an opening or carry-forward balance and would record each transaction as either a debit or credit in separate columns (resulting in an update to the ending or closing balance.)

During operation, participants provide transaction records to the transaction ledger application. A transaction record between an active participant and a passive participant may be verified for entry based on an authentication and/or authorization process. Here, “verification” and its linguistic variants refers to the steps taken to verify that the transaction record is a truthful accounting of the cooperative bargaining process. “Authentication” and its linguistic variants refers to the process of identifying the participants identity, “authorization” and its linguistic variants refers to the process of determining the participant's authorization to attest to the transaction.

For example, a transaction ledger could determine that the proposed transaction record was generated by an entity other than the account holder (failure to authenticate). In another example, a transaction ledger could determine that the participant is not authorized to modify the exchange rate in the proposed manner (unauthorized modification.) More generally, any verification process may be substituted with equal success, by artisans of ordinary skill in the related arts given the contents of the present disclosure.

After the verification process, the transaction ledger reconciles all accounts. During the reconciliation process, each and every debit recorded in a ledger must correspond to a credit and vice versa (double entry accounting), so that the debits equal the credits in total. In some cases, irreconcilable differences may be provided to a review process for review and reconciliation. Additionally, certain transactions may be flagged and provided for external remediation (if necessary).

The closing balances for each account holder are updated after reconciliation, and a final accounting may be provided. Final accounting may be pushed to participants or alternatively requested by participants as-needed.

### Overview of User Device

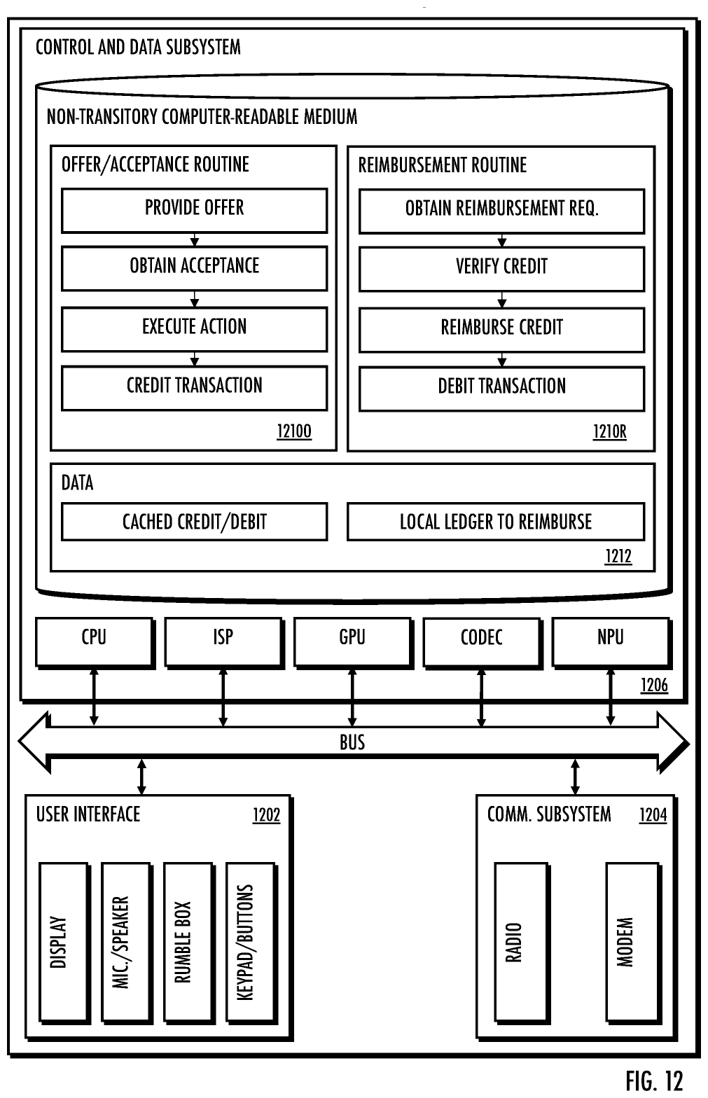

FIG. 12 is a logical block diagram of an exemplary user device (e.g., user devices 1200 of FIG. 6). The user device includes: a user interface subsystem 1202, a communication subsystem 1204, a control and data subsystem 1206, and a bus to enable data transfer. The user device has many similarities in operation and implementation to the fleet device which are not further discussed below, the following discussion provides a discussion of the internal operations, design considerations, and/or alternatives, that are specific to user device operation.

### User Device: User Interface

In one embodiment, the user interface subsystem 1202 may be used to present media to, and/or receive input from, a human user. In some embodiments, media may include audible, visual, and/or haptic content. Examples include images, videos, sounds, and/or vibration. Visual content may be displayed on a screen or touchscreen. Sounds and/or audio may be presented to the user via a microphone and speaker assembly. In some situations, the user may be able to interact with the device via voice commands to enable hands-free operation. Additionally, rumble boxes and/or other vibration media may playback haptic signaling.

In some embodiments, input maybe interpreted from touchscreen gestures, button presses, device motion, and/or commands (verbally spoken). The user interface subsystem may include physical components (e.g., buttons, keyboards, switches, scroll wheels, etc.) or virtualized components (via a touchscreen).

In some cases, the user may configure their user interface preferences based on their driving needs. Some users may prefer to use text notifications, audible notifications, or haptic notifications. Similarly, users may prefer to use touchscreen and/or keypad access for responses (in addition to their pre-existing driving signals).

### User Device: Communication Subsystem

The communication subsystem 1204 of the user device 1200 may include one or more radios and/or modems. In one exemplary embodiment, the radio and modem are configured to communicate over the “last mile” using a 5^{th} Generation (5G) cellular network. In one exemplary embodiment, the user device may connect to the cellular network with best effort and/or low data requirements (e.g., via 5G eMBB or mMTC network slices discussed in greater detail below) to communicate transaction data with the transaction ledger. In some implementations, the communication network may also enable the fleet device to discover and/or communicate with nearby participants with best effort and/or low data requirements.

### User Device: Control and Data Subsystem

The control and data subsystem 1206 controls the user device's operation and store and process transaction data. In one exemplary embodiment, the control and data subsystem uses processing units that execute instructions stored in non-transitory computer-readable medium (memory). More generally however, other forms of control and/or data may be substituted with equal success, including e.g., neural network processors, dedicated logic (field programmable gate arrays (FPGAs), application specific integrated circuits (ASICs)), and/or other software, firmware, and/or hardware implementations. As shown in FIG. 12, the control and data subsystem may include one or more of: a central processing unit (CPU), an image signal processor (ISP), a graphics processing unit (GPU), a codec, a neural network processor (NPU), and a non-transitory computer-readable medium that stores program instructions and/or data.

### User Device: Logical Operation

Referring back to FIG. 12, the non-transitory computer-readable medium may be used to store data locally at the user device. In one exemplary embodiment, data may be stored as non-transitory symbols (e.g., bits, bytes, words, and/or other data structures.) In one specific implementation, the memory subsystem is realized as one or more physical memory chips (e.g., NAND/NOR flash) that are logically separated into memory data structures. The memory subsystem may be bifurcated into program code (e.g., offer/acceptance routine 1210O, and reimbursement routine 1210R) and/or program data 1212. In some variants, program code and/or program data may be further organized for dedicated and/or collaborative use. For example, the GPU and CPU may share a common memory buffer to facilitate large transfers of data. Similarly, the codec may have a dedicated memory buffer to avoid resource contention.

In one embodiment, the program code includes instructions that when executed by the processor subsystem cause the processor subsystem to perform tasks which may include: calculations, and/or actuation of the user interface subsystem 1202 and/or communication subsystem 1204. In some embodiments, the program code may be statically stored within the user device 1200 as firmware. In other embodiments, the program code may be dynamically stored (and changeable) via software updates. In some such variants, software may be subsequently updated by external parties and/or the user, based on various access permissions and procedures.

In one exemplary embodiment, the non-transitory computer-readable medium includes an offer/acceptance routine 1210O. When executed by the control and data subsystem, the offer/acceptance routine 1210O causes the user device to: provide an offer to an other participant; obtain acceptance from the other participant; execute the maneuver; and credit the transaction to the other participant.

In one exemplary embodiment, the non-transitory computer-readable medium includes a reimbursement routine 1210R. When executed by the control and data subsystem, the reimbursement routine 1210R causes the user device to: obtain a reimbursement request from an other participant; verify a credit associated with the other participant; responsive to successful verification, reimburse the credit; and debit the transaction from the other participant.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

1. (canceled)

2. A self-driving fleet vehicle, comprising;
a signaling subsystem comprising a turn signal;
a sensor subsystem comprising a front camera;
a communication subsystem comprising a cellular modem; and
a control and data subsystem comprising at least a processor and a non-transitory computer-readable medium, where the non-transitory computer-readable medium includes instructions that, when executed by the processor, cause the self-driving fleet vehicle to:
request a lane change to a driver via the turn signal;
detect an acceptance of the lane change from the driver via the front camera;
responsive to the acceptance, execute the lane change;
document a transaction record, the transaction record comprising a driver identification, a fleet vehicle identification, and a credit value; and
transmit the transaction record to a transaction ledger via the communication subsystem.

3. The self-driving fleet vehicle of claim 2, where the sensor subsystem further comprises a rear camera and where the driver identification is based on an image of a license plate captured via the rear camera.

4. The self-driving fleet vehicle of claim 2, where the cellular modem transmits the transaction record with best effort delivery.

5. The self-driving fleet vehicle of claim 2, where the front camera has a visual range of 100 to 300 yards and a field of view 35°.

6. The self-driving fleet vehicle of claim 2, where the control and data subsystem further comprises a neural network processor and where the credit value is determined by the neural network processor.

7. The self-driving fleet vehicle of claim 2, further comprising a vehicle chassis configured to convey a human passenger.

8. The self-driving fleet vehicle of claim 7, where the control and data subsystem is removably mounted to the vehicle chassis.

9. A self-driving fleet vehicle, comprising;
a signaling subsystem comprising a brake signal;
a sensor subsystem comprising a rear camera;
a communication subsystem comprising a cellular modem; and
a control and data subsystem comprising at least a processor and a non-transitory computer-readable medium, where the non-transitory computer-readable medium includes instructions that, when executed by the processor, cause the self-driving fleet vehicle to:
detect a lane change request from a driver via the rear camera;
determine whether the driver has a credit within a local ledger of credits;
signal an acceptance to the driver via the brake signal;
create space for the driver;
responsive to a successful lane change, document a transaction record, the transaction record comprising a driver identification, a fleet vehicle identification, and a debit; and
transmit the transaction record to a transaction ledger via the communication subsystem.

10. The self-driving fleet vehicle of claim 9, where the driver identification comprises an image of a license plate captured via the rear camera.

11. The self-driving fleet vehicle of claim 9, where the sensor subsystem further comprises a front camera and where the successful lane change is based on footage captured by the front camera.

12. The self-driving fleet vehicle of claim 9, where the cellular modem transmits the transaction record with best effort delivery.

13. The self-driving fleet vehicle of claim 9, further comprising a vehicle chassis configured to convey a human passenger.

14. The self-driving fleet vehicle of claim 13, where the control and data subsystem is removably mounted to the vehicle chassis.

15. A method for human-to-machine negotiation, comprising:
requesting a first lane change to a human driver via a first fleet vehicle of a fleet entity;
detecting an acceptance from the human driver via the first fleet vehicle;
responsive to the acceptance, executing the first lane change via the first fleet vehicle;
documenting a first transaction record, the first transaction record comprising a driver identification and a credit value;
detecting a lane change request from the human driver via a different fleet vehicle of the fleet entity;
allowing the human driver to perform a second lane change at the different fleet vehicle; and
responsive to a successful second lane change, documenting a second transaction record, the second transaction record comprising the driver identification and a debit value.

16. The method of claim 15, where the fleet entity controls a plurality of self-driving vehicles.

17. The method of claim 15, where the fleet entity controls a plurality of human driven vehicles.

18. The method of claim 15, where the first transaction record and the second transaction record are stored within a transaction ledger.

19. The method of claim 18, where the human driver is associated with a user account and the fleet entity is associated with a fleet account of the transaction ledger.

20. The method of claim 19, where the transaction ledger is distributed across multiple entities.

21. The method of claim 15, where the fleet entity communicates with the first fleet vehicle and the different fleet vehicle according to best effort delivery.
